(19) United States
(12) Patent Application Publication
(10) Pub. No.: US 2011/0035215 A1
(43) Pub. Date: Feb. 10, 2011

(54) METHOD, DEVICE AND SYSTEM FOR SPEECH RECOGNITION

(76) Inventors: Haim Sompolinsky, Jerusalem (IL); Robert Guetig, Berlin (DE)

Correspondence Address: Professional Patent Solutions, P.O. BOX 654, HERZELIYA PITUACH, 46105, IL

(21) Appl. No.: 12/675,144

(22) PCT Filed: Aug. 28, 2008
(86) PCT No.: PCT/IL08/01171

§ 371 Date: Oct. 18, 2010

Related U.S. Application Data
(60) Provisional application No. 60/999,757, filed on Aug. 28, 2007.

(51) Int. Cl. G10L 15/00

(52) U.S. Cl. 704/231; 704/E15.001

(57) ABSTRACT

Disclosed is a method and apparatus for signal processing and signal pattern recognition. According to some embodiments of the present invention, events in the signal to be processed/recognized may be used to pace or clock the operation of one or more processing elements. The detected events may be based on signal energy level measurements. The processing/recognition elements may be neuron models. The signal to be processed/recognized may be a speech signal.

### FIELD OF THE INVENTION

The present invention relates generally to the field of communication and processing. More specifically, the present invention relates to method device and system for speech recognition.

### BACKGROUND

Speech recognition (also known as automatic speech recognition or computer speech recognition) converts spoken words to machine-readable input (for example, to key presses, using the binary code for a string of character codes). The term voice recognition may also be used to refer to speech recognition, but more precisely refers to speaker recognition, which attempts to identify the person speaking, as opposed to what is being said.

Speech recognition applications include voice dialing (e.g., “Call home”), call routing (e.g., “I would like to make a collect call”), domotic appliance control and content-based spoken audio search (e.g., find a podcast where particular words were spoken), simple data entry (e.g., entering a credit card number), preparation of structured documents (e.g., a radiology report), speech-to-text processing (e.g., word processors or emails), and in aircraft cockpits (usually termed Direct Voice Input).

The performance of speech recognition systems is usually specified in terms of accuracy and speed. Accuracy may be measured in terms of performance accuracy which is usually rated with word error rate (WER), whereas speed is measured with the real time factor. Other measures of accuracy include Single Word Error Rate (SWER) and Command Success Rate (CSR).

Commercially available speaker-dependent dictation systems usually require a period of training (sometimes also called ‘enrollment’) and may successfully capture continuous speech with a large vocabulary at normal pace with a very high accuracy. Most commercial companies claim that recognition software can achieve between 98% to 99% accuracy if operated under optimal conditions. ‘Optimal conditions’ usually assume that users:
have speech characteristics which match the training data,
can achieve proper speaker adaptation, and
work in a clean noise environment (e.g. quiet office or laboratory space).

Some users, especially those whose speech is heavily accented, might achieve recognition rates much lower than expected. Speech recognition in video has become a popular search technology used by several video search companies.

Both acoustic modeling and language modeling are important parts of modern statistically-based speech recognition algorithms. Hidden Markov Models (HMMs) are widely used in many systems. Language modeling has many other applications such as smart keyboard and document classification.

Modern general-purpose speech recognition systems are generally based on HMMs. These are statistical models which output a sequence of symbols or quantities. One possible reason why HMMs are used in speech recognition is that a speech signal could be viewed as a piecewise stationary signal or a short-time stationary signal. That is, one could assume in a short-time in the range of 10 milliseconds, speech could be approximated as a stationary process. Speech could thus be thought of as a Markov model for many stochastic processes.

Another reason why HMMs are popular is because they can be trained automatically and are simple and computationally feasible to use. In speech recognition, the hidden Markov model would output a sequence of n-dimensional real-valued vectors (with n being a small integer, such as 10), outputting one of these every 10 milliseconds. The vectors would consist of cepstral coefficients, which are obtained by taking a Fourier transform of a short time window of speech and decorrelating the spectrum using a cosine transform, then taking the first (most significant) coefficients. The hidden Markov model will tend to have in each state a statistical distribution that is a mixture of diagonal covariance Gaussians which will give a likelihood for each observed vector. Each word, or (for more general speech recognition systems), each phoneme, will have a different output distribution; a hidden Markov model for a sequence of words or phonemes is made by concatenating the individual trained hidden Markov models for the separate words and phonemes.

Described above are the core elements of the most common, HMM-based approach to speech recognition. Modern speech recognition systems use various combinations of a number of standard techniques in order to improve results over the basic approach described above. A typical large-vocabulary system would need context dependency for the phonemes (so phonemes with different left and right context have different realizations as HMM states); it would use cepstral normalization to normalize for different speaker and recording conditions; for further speaker normalization it might use vocal tract length normalization (VTLN) for male-female normalization and maximum likelihood linear regression (MLLR) for more general speaker adaptation. The features would have so-called delta and delta-delta coefficients to capture speech dynamics and in addition might use heteroscedastic linear discriminant analysis (HLDA); or might skip the delta and delta-delta coefficients and use splicing and an LDA-based projection followed perhaps by heteroscedastic linear discriminant analysis or a global semitied covariance transform (also known as maximum likelihood linear transform, or MLLT). Many systems use so-called discriminative training techniques which dispense with a purely statistical approach to HMM parameter estimation and instead optimize some classification-related measure of the training data. Examples are maximum mutual information (MMI), minimum classification error (MCE) and minimum phone error (MPE). Decoding of the speech (the term for what happens when the system is presented with a new utterance and must compute the most likely source sentence) would probably use the Viterbi algorithm to find the best path, and here there is a choice between dynamically creating a combination hidden Markov model which includes both the acoustic and language model information, or combining it statically beforehand (the finite state transducer, or FST, approach).

Fluctuations in the temporal durations of sensory signals constitute a major source of variability within natural stimulus ensembles. The neuronal mechanisms through which sensory systems can stabilize perception against such fluctuations are largely unknown. An intriguing instantiation of such robustness occurs in human speech perception which relies critically on temporal acoustic cues that are embedded in signals with highly variable duration. Across different instances of natural speech auditory cues can undergo temporal warping that ranges from two-fold compression to two-fold dilation without noticeable perceptual impairment. Thus, processing of complex natural stimuli, such as speech, often requires two seemingly conflicting capabilities. On one hand, temporal features of incoming signals must be extracted and integrated over a wide range of different time scales. On the other hand, information processing systems must be invariant with respect to substantial temporal variability of input signals.

Dynamic Time Warping (“DTW”) is one prior art approach that was used by speech recognition systems to deal with speech timing variations, but has now largely been displaced by the more successful HMM-based approach. Dynamic time warping is an algorithm for measuring similarity between two sequences which may vary in time or speed. DTW does not provide a system with time-warping invariance, but rather attempts to dynamically compensate for time-warping.

There is a need in the field of speech processing and speech recognition for improved methods, devices and systems. There is a further need for speech processing/recognition methods, devices and systems which may compensate for, or be otherwise immune to, time variations in a speech signal (i.e. time-warping).

### SUMMARY OF THE INVENTION

The present invention is a method, device and system for providing signal pattern (e.g. speech signal) processing and recognition. According to some embodiments of the present invention, speech recognition may be achieved by factoring in or compensating for dynamic time-warping of an input speech signal by adjustment of intrinsic pacing or clocking of signal processing elements in a pattern (e.g. speech pattern) processing system. Pacing or clocking of one or more signal processing elements may be based on detection of events, such as temporal events, in the signal being processed or recognized. According to some embodiments of the present invention, temporal patterns of events within a speech signal may be identified and used to adjust the rate at which one or more speech processing elements process the speech signal. According to some embodiments of the present invention, the events may be predefined threshold crossings of power-spectral densities of the speech signal filtered spatiotemporally. According to further embodiments of the present invention, the events may be threshold crossings of dynamically determined power-spectral density levels of the speech signal filtered spatiotemporally. According to further embodiments of the present invention, speech processing elements may include a neural network model such as one or more neuron models, one or more tempotron models and/or one or more conductance based tempotron models.

According to some embodiments of the present invention, a time domain signal representing an utterance of speech (i.e. a word or phoneme) may be characterized in the frequency domain, across multiple windows in the time domain (i.e. spatiotemporal characterization). According to further embodiments of the present invention, spatiotemporal characterization may produce a set of pulses or spikes, each of which pulses or spikes may be associated with a specific energy level in a specific energy band of the speech signal. The spatiotemporal characterization output may be received and may be used by one or more signal or speech signal processing elements or systems. According to some embodiments of the present invention, the spatiotemporal characterization output may influence a pace or rate of operation (e.g. provide a clocking signal or adjust a clocking signal) of one or more elements in the readout stage of a recognition system. Any recognition readout elements and methodologies, known today or to be devised in the future, may be applicable to the present invention. Any method of detecting events in a speech signal and producing an output signal usable for the regulation of downstream clocking, known today or to be devised in the future, may be applicable to the present invention.

According to further embodiments of the present invention, readout or recognition elements may include one or more neuron models. According to some embodiments of the present invention, the set of pulses or spikes produced by spatiotemporal characterization may be applied to one or a set of neuron models such as a tempotrons (i.e. a neuron or neuron model that can learn spike timing based decision making). According to further embodiments of the present invention, the tempotrons may be conductance based tempotrons. According to a more specific embodiment of the present invention, conductance based tempotrons may be applied to the TI46 isolated digits speech recognition task. Using a simple model of the auditory periphery, sound signals may be converted into patterns of events by thresholding their spatiotemporally filtered power-spectral densities (i.e. “spatiotemporally characterized”) and fed into a small population of conductance-based tempotrons neurons, each of which is trained or otherwise associated with a different word or phoneme.

Each neuron model may be trained or otherwise associated/correlated with a pulse pattern related to a specific phoneme or to an entire word utterance. And, according to some embodiments of the present invention, the word associated with the first, or substantially the first, neuron model to be triggered as a result of receiving the pulses may be designated the recognized word. In cases where the recognition/readout elements are associated with phonemes, a subsequent word recognition stage may be used to correlate identified phonemes with specific words.

Spatiotemporal characterization of an utterance according to some embodiments of the present invention may include detecting energy level crossings across each of a set of predefined energy levels within each of a set of predefined frequency bands. According to further embodiments of the present invention, the energy level within each of the set of frequency bands may be dynamically determined based on the overall energy within the band or the overall energy within the signal, or based on any other method known today or to be devised in the future. Detection of each of the energy level crossings within each of the frequency bands may be performed using either analog or frequency filtering. According to embodiments of the present invention an analog signal representing the speech utterance may be passed in parallel over or through a filter bank including a set of analog band-pass filters, wherein each filter in the set is adapted to only pass frequency components of the signal within a predefined band of frequencies. The output of each of the filters may be monitored by a signal energy detector adapted to receive the output of the filter and to output a pulse on a given output line each time the instantaneous energy level of the input signal crosses a predefined energy level associated with the given output line. If, for example, the detector is configured to detect ten predefined energy level crossings, it may also include ten output lines, such that detection of a crossing of each of the ten energy levels triggers an output pulse on a separate one of the ten output lines, where each specific output line is associated with a specific crossing level. According to further embodiments of the present invention, the detector receiving the output of a given filter may include two output lines associated with some or all of its predefined energy level crossings, such that a pulse is triggered on a first of the two output lines when there is an upward crossing of the predefined level, and a pulse is triggered on a second of the two output lines when there is a downward crossing of the predefined level. Thus, if for example, according to an embodiment of the present invention a speech signal were spectrally characterized using ten band pass filters and ten energy detectors, each of which is adapted to detect ten separate energy level crossings, there would be one hundred output lines according to a scenario where each crossing on each detector is associated with a single output line, and two hundred output lines in the scenario where each crossing on each detector is associated with two output lines (e.g. an upward crossing line and a downward crossing line).

It should be understood by one or ordinary skill in the art that both the filters and the detectors can be implement according to one of numerous techniques known today or to be devised in the future. According to some embodiments of the present invention, any combination of filters and detectors can be integrated into a single circuit or device.

Spectral characterization of a speech utterance signal according to some embodiments of the present invention may also be achieved digitally. For Example, a speech utterance signal may be sampled, by for example an analog to digital converter (“A/D”). Alternatively, the source of the speech signal may be a digitally stored file. The data stream output of the A/D or the digital file (i.e. digital speech signal), representing the speech signal as set of values, may be spectrally decomposed to determine frequency components (e.g. energy levels) at different frequency bands using any of the known techniques, including passing the data stream, in parallel through, a digital filter bank including a set of digital band-pass filters (e.g. Field Programmable Gate Array—FPGA), wherein each filter in the set is adapted to only pass frequency components of the digital signal only within a predefined band of frequencies. The output of each of the digital filters may be monitored by a signal energy detector adapted to receive the output of the filter and to output a pulse on a given output line each time the instantaneous energy level of the input signal crosses a predefined energy level associated with the given output line. If, for example, the detector is configured to detect ten predefined energy level crossings, it may also include ten output lines, such that detection of a crossing of each of the ten energy levels triggers an output pulse on a separate one of the ten output lines, where each specific output line is associated with a specific crossing level. According to further embodiments of the present invention, the detector receiving the output of a given filter may include two output lines associated with some or all of its predefined energy level crossings, such that a pulse is triggered on a first of the two output lines when there is upward crossing of the predefined level, and a pulse is triggered on a second of the two output lines when there is a downward crossing of the predefined level. Thus, if for example, according to an embodiment of the present invention a speech signal were spectrally characterized using ten band pass filters and ten energy detectors, each of which is adapted to detect ten separate energy level crossings, there would be one hundred output lines according to a scenario where each crossing on each detector is associated with a single output line, and two hundred output lines in the scenario where each crossing on each detector is associated with two output lines (e.g. an upward crossing line and a downward crossing line).

Alternatively, the digital filters and the detectors can be implemented in software running on a single processor or across a set of interconnected processors (e.g. General Purpose Processors or Digital Signal Processors). For example, a Fourier or Fast Fourier Transform (“FFT”) may be performed on portions of the digital time domain signal, using a sliding sample window, to produce a set of corresponding frequency domain windows—each of which including a set of values where each value represents an amplitude levels of a discrete frequency components in the digital speech signal. It is known how to calculate in software an instantaneous energy level of a given frequency band of a digital signal based on an FFT of the digital signal. There are also known programming techniques to track a set of values (e.g. calculated energy level) across multiple FFT windows and to trigger a specific event (i.e. a software version of a pulse on a given output line) associated with a specific crossing by the set of values of a predefined value. Thus, it should be clear to one or ordinary skill in the art that any suitable digital processing techniques, known today or to be devised in the future, may be combined to perform spectral characterization according to some embodiments of the present invention may be achieved digitally using.

According to further embodiments of the present invention, any crossing of any value of a derivate (first, second, third, etc.) of an energy level related parameter (e.g. power spectrum density) within each of the frequency bands may be defined as a separate event. It should be understood that the reaching or crossing of any value (predefined or dynamically defined based on the signal characteristics) calculated as any arithmetic combination of a signal energy parameter, and/or its derivates, in a single frequency band or across multiple frequency bands, may be defined as an event for the purposes of the present invention. The number of possible combinations and permutations of derived values is infinite and one or ordinary skill in the art of signal processing should understand that any such combination or permutation may be applicable to the present invention. Each event, regardless of its possible definition, may be associated with a separate spike or pulse line.

According to some embodiments of the present invention, a neuron model such as a tempotron or a conductance based tempotron may be trained or otherwise associated by adjusting a weighting factor associated with each of the pulse (impulse) lines feeding into the neuron model. The set of weighting factors for each neuron model, wherein a neuron model is correlated with a specific phoneme or word, may be determined or selected based on speech samples of the given word.

According to some embodiments of the present invention, a conductance-based time-resealing mechanism may be based on the biophysical property of neurons that their effective integration time may be shaped by synaptic conductances and may be modulated by the firing rate of afferents. To utilize these modulations for time-warp invariant processing, there may be a large evoked total synaptic conductance that dominates the effective integration time constant of the post-synaptic cell through shunting. Large synaptic conductances with a median value of a threefold leak conductance across all digit detector neurons may result from a combination of excitatory and inhibitory inputs.

A large total synaptic conductance is associated with a substantial reduction in a neuron's effective integration time relative to its resting value. Therefore, the resting membrane time constant of a neuron that implements the automatic time resealing mechanism may substantially exceed the temporal resolution that is required by a given recognition or identification task. Because the word recognition tasks may comprise whole word stimuli that favored effective time constants on the order of several tens-of-milliseconds, a resting membrane time constant of Tₘ=100 ms may be used.

To utilize synaptic conductances as efficient controls of the neuron's clock, the peak synaptic conductances may be plastic so as to adjust to the range of integration times relevant for a given perceptual recognition task. This may be achieved using a supervised spike-based learning rule. This plasticity posits that the temporal window during which pre and post-synaptic activity interact, continuously adapts to the effective integration time of the post-synaptic cell. The polarity of synaptic changes may be determined by a supervisory signal that may be realized through neuromodulatory control. According to further embodiments of the present invention, a supervised spike-based learning rule adjusts synaptic peak conductances after each error-trial by an amount which reflects each synapse's contribution to the maximum post-synaptic membrane potential, increasing it when the neuron failed to detect a target and decreasing it if the neuron triggered erroneously.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a functional block diagram of an exemplary signal pattern recognition system according to some embodiments of the present invention;

FIG. 1B shows a flow chart including the steps of a method by which the pattern recognition system of FIG. 1A may be operated;

FIG. 2A shows a functional block diagram of an exemplary speech signal recognition system according to some embodiments of the present invention;

FIG. 2B shows a flow chart including the steps of a method by which the pattern recognition system of FIG. 2A may be operated;

FIG. 3A shows a functional block diagram of an exemplary speech signal recognition system according to some embodiments of the present invention;

FIG. 3B shows a flow chart including the steps of a method by which the pattern recognition system of FIG. 3A may be operated;

FIG. 4 relates to Time-warp in natural speech in accordance with the specific exemplary embodiment of the present invention: Sound pressure waveforms (upper panels, arbitrary units) and spectrograms (lower panels, color code scaled between the minimum and maximum log power) of speech samples from the TI46-Word corpus [22], spoken by different male speakers. A and B, utterances of the word “one”. Thin black lines highlight the transients of the second, third and fourth (bottom to top) spectral peaks (formants). The lines in panel a are compressed relative to panel B by a common factor of 0.53. C and D, utterances of the word “eight”;

FIG. 5 relates to Classification of time-warped random latency patterns in accordance with the specific exemplary embodiment of the present invention: A, Error probabilities vs. the scale of global time-warp βₘₐₓ for the conductance-based (blue) and the current-based (red) neurons. Errors were averaged over 20 realizations, error bars depict ±1 s.d. Isolated points on the right were obtained under dynamic time-warp with βₘₐₓ=2.5 (Methods). B Dependence of the error frequency at βₘₐₓ=2.5 on the resting membrane time constant τₘ (left) and the synaptic time constant τₛ (right). Colors and statistics as in A. C Voltage traces of a conductance-based (top and 2nd rows) and a current-based neuron (3rd and bottom rows). Each trace was computed under global time-warp with a temporal scaling factor β (Methods) (colorbar) and plotted vs. a common resealed time axis. For each neuron model, the upper traces were elicited by a target and the lower traces by an untrained spike template;

FIG. 6 relates to Adaptive learning kernel in accordance with the specific exemplary embodiment of the present invention: Change in synaptic peak conductance Δg vs. the time difference Δt between synaptic firing and the voltage maximum, as a function of the mean total synaptic conductance G during this interval (colorbar). Data were collected during the initial 100 cycles of learning with βₘₐₓ=2.5 and averaged over 100 realizations;

FIG. 7 relates to Task dependence of the learned total synaptic conductance in accordance with the specific exemplary embodiment of the present invention: Error frequency of the conductance-based tempotron vs. its effective integration time τ_{eff}. After switching from time-warp to Gaussian spike jitter, τ_{eff} increased as the mean time averaged total synaptic conductance G decreased with learning time (inset);

FIG. 8 relates to Auditory front-end in accordance with a specific exemplary embodiment of the present invention: A Incoming sound signal (bottom) and its spectrogram in linear scale (top) as in FIG. 4D. Based on the spectrogram the log signal power in 32 frequency channels (Mel scale, Methods) is computed and normalized to unit peak amplitude in each channel (B, top, colorbar). Black lines delineate filterbank channels 10, 20 and 30 and their respective support in the spectrogram (connected through grey areas). In each channel spikes in 31 afferents (small black circles) are generated by 16 onset (upper block) and 15 offset (lower block) thresholds. For the signal in channel 1 (shown twice as thick black curves on the front sides of the upper and lower blocks), resulting spikes are marked by circles (onset) and squares (offset) with colors indicating respective threshold levels (colorbar). C Spikes (onset, top and offset, bottom) from all 992 afferents plotted as a function of time (x-axis) and corresponding frequency channel (yaxis). The color of each spike (short thin lines) indicates the threshold level (as used for circles and squares in B) of the eliciting unit;

FIG. 9 relates to Speech recognition task in accordance with the specific exemplary embodiment of the present invention: A, Learned synaptic peak conductances. Each pixel corresponds to one synapse characterized by its frequency channel (right y-axis) and its onset (ON) or offset (OFF) afferent power threshold level (x-axis, in percent of maximum signal powers (Methods)). Learned peak conductances were color coded with excitatory (warm colors) and inhibitory conductances (cool colors) separately normalized to their respective maximal values (colorbar). The left y-axis shows the logarithmically spaced center frequencies (Mel scale) of the frequency channels. B, Spike triggered target stimuli (color code scaled between the minimum and maximum mean log power). C, Mean voltage traces for target (blue, light blue ±1 s.d.; spike triggered) and null stimuli (red; maximum triggered);

FIG. 10 relates to Time-warp robustness in accordance with the specific exemplary embodiment of the present invention: A, Error vs. time-warp factor β. B, Mean errors over the range of β shown in A (digit color code; triangles: female speakers, circles: male speakers) vs. the mean effective time constant τ_{eff} calculated for β=1 by averaging the total synaptic conductance over 100 ms time windows prior to either the output spikes (target stimuli) or the voltage maxima (null stimuli). C, Mean voltage traces for time-warped target patterns for the neurons shown in FIG. 9. Bottom row: conductance-based neurons, upper row: current-based neurons (Methods); and

FIG. 11 is a table that relates to Test set error fractions of individual detector neurons in accordance with the specific exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

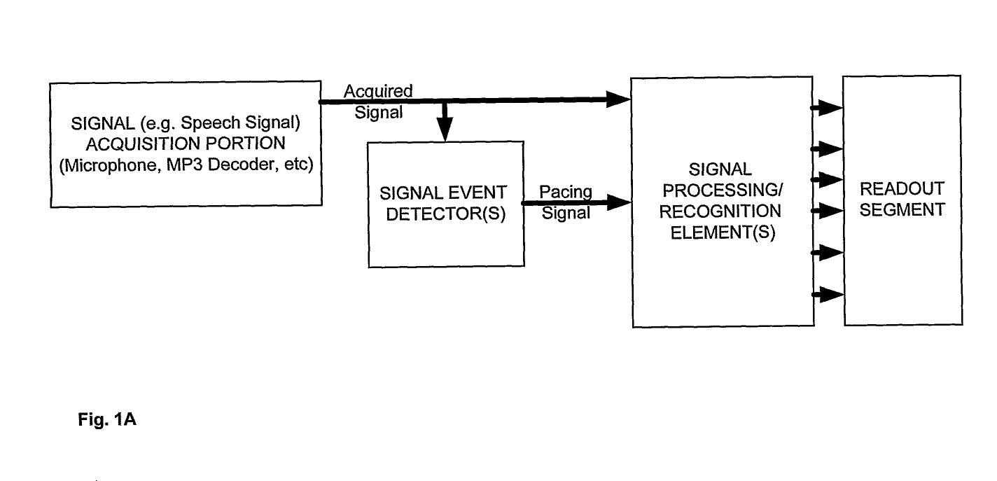

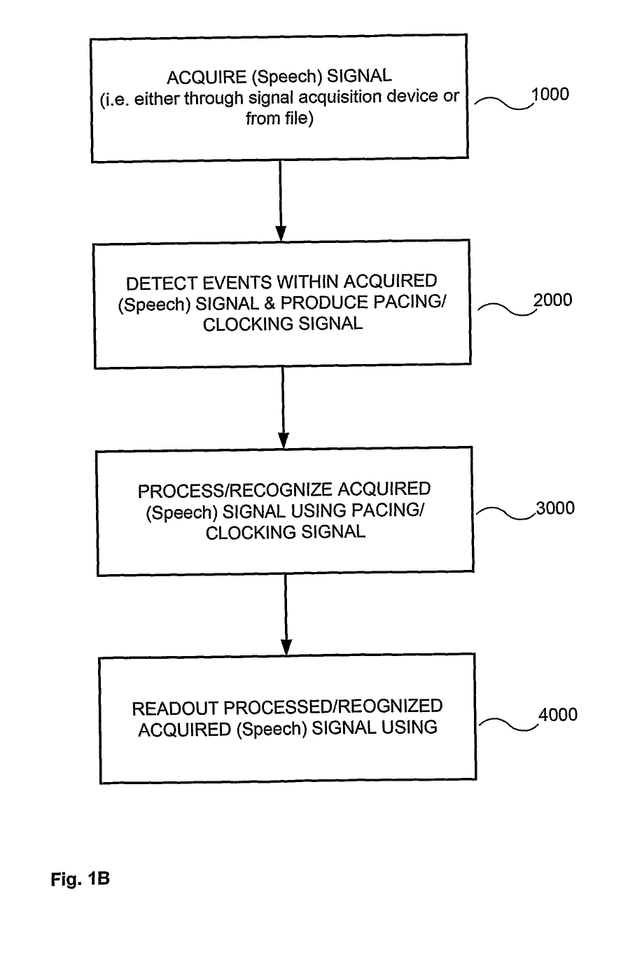

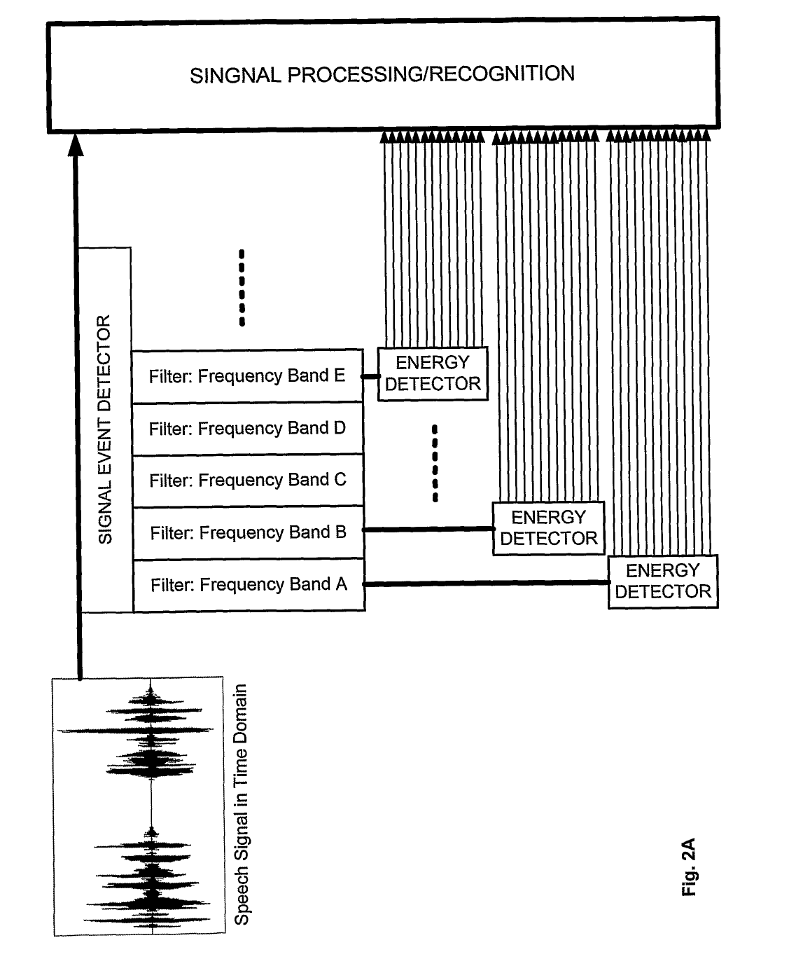

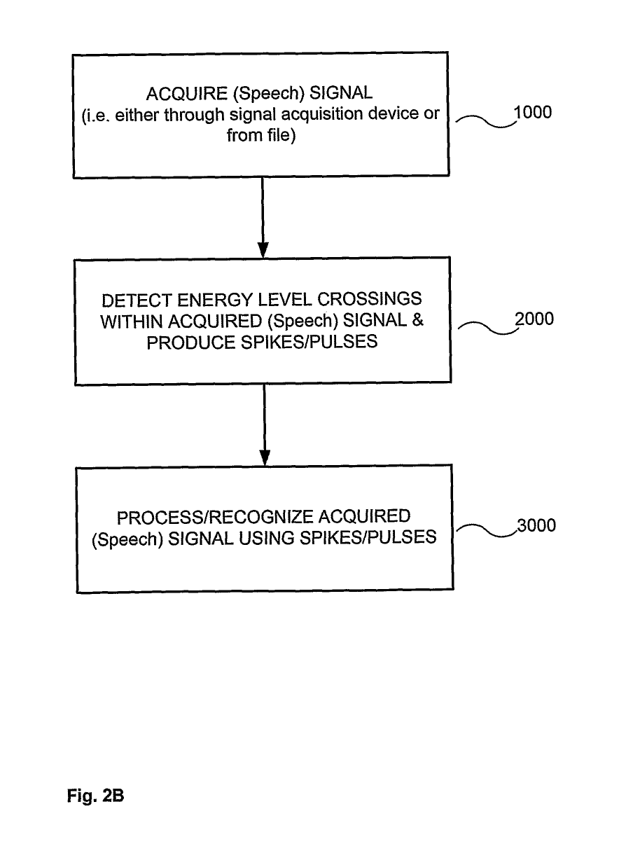

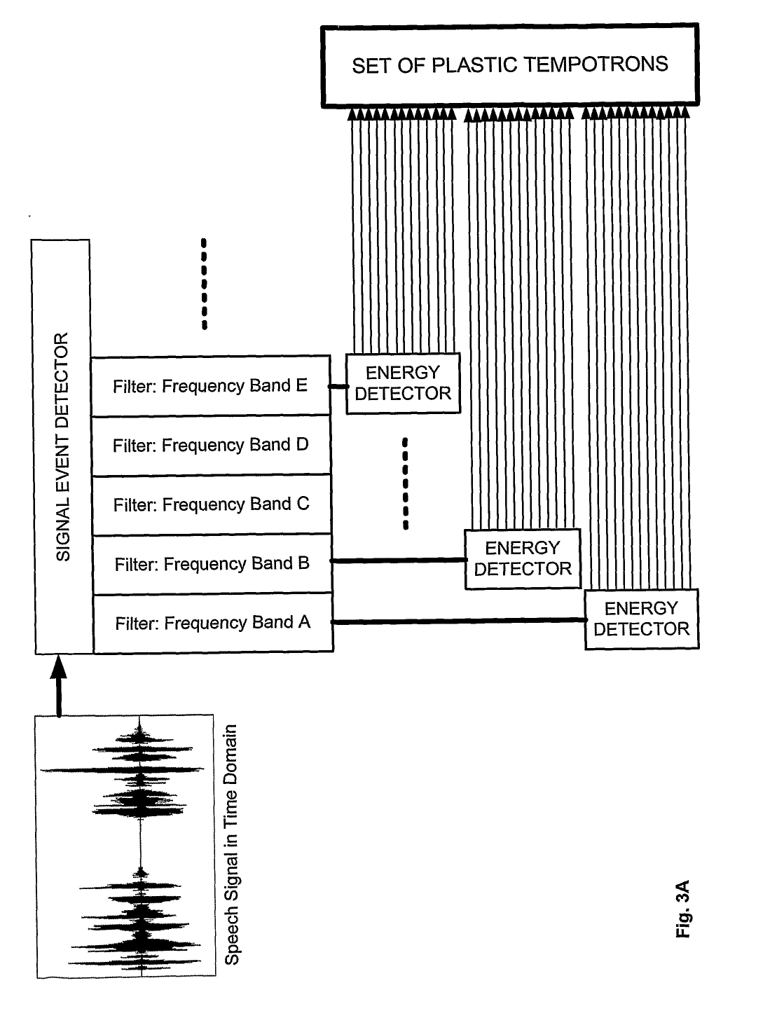

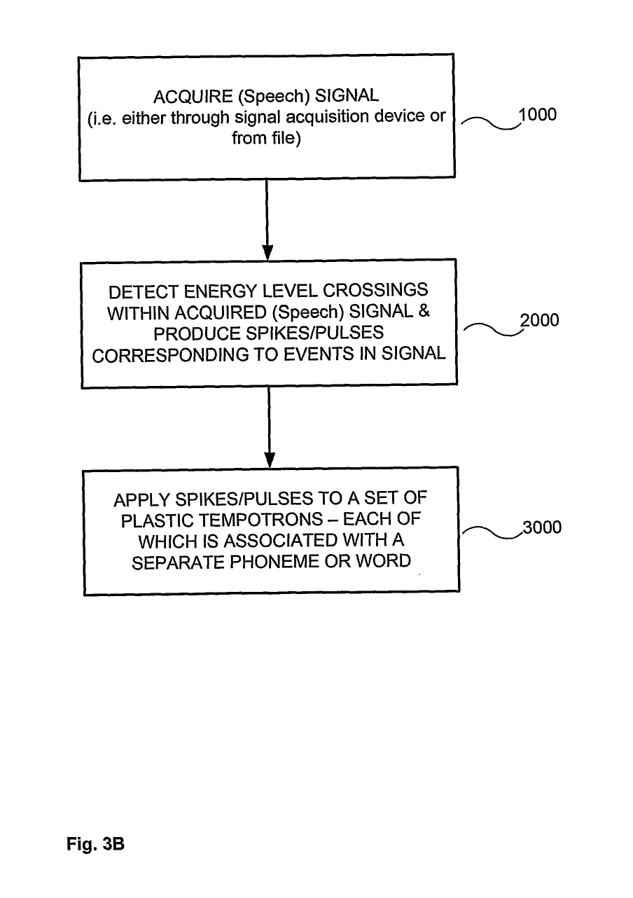

The following description is provided in conjunction with FIGS. 1A through 3B which show block diagrams and flow charts relating to the various embodiments of the present invention.

The present invention is a method, device and system for providing signal pattern (e.g. speech signal) processing and recognition. According to some embodiments of the present invention, speech recognition may be achieved by factoring in or compensating for dynamic time-warping of an input speech signal by adjustment of intrinsic pacing or clocking of signal processing elements in a pattern (e.g. speech pattern) processing system. Pacing or clocking of one or more signal processing elements may be based on detection of events, such as temporal events, in the signal being processed or recognized. According to some embodiments of the present invention, temporal patterns of events within a speech signal may be identified and used to adjust the rate at which one or more speech processing elements process the speech signal. According to some embodiments of the present invention, the events may be predefined threshold crossings of power-spectral densities of the speech signal filtered spatiotemporally. According to further embodiments of the present invention, the events may be threshold crossings of dynamically determined power-spectral density levels of the speech signal filtered spatiotemporally. According to further embodiments of the present invention, speech processing elements may include a neural network model such as one or more neuron models, one or more tempotron models and/or one or more conductance based tempotron models.

According to some embodiments of the present invention, a time domain signal representing an utterance of speech (i.e. a word or phoneme) may be characterized in the frequency domain, across multiple windows in the time domain (i.e. spatiotemporal characterization). According to further embodiments of the present invention, spatiotemporal characterization may produce a set of pulses or spikes, each of which pulses or spikes may be associated with a specific energy level in a specific energy band of the speech signal. The spatiotemporal characterization output may be received and may be used by one or more signal or speech signal processing elements or systems. According to some embodiments of the present invention, the spatiotemporal characterization output may influence a pace or rate of operation (e.g. provide a clocking signal or adjust a clocking signal) of one or more elements in the readout stage of a recognition system. Any recognition readout elements and methodologies, known today or to be devised in the future, may be applicable to the present invention. Any method of detecting events in a speech signal and producing an output signal usable for the regulation of downstream clocking, known today or to be devised in the future, may be applicable to the present invention.

According to further embodiments of the present invention, readout or recognition elements may include one or more neuron models. According to some embodiments of the present invention, the set of pulses or spikes produced by spatiotemporal characterization may be applied to one or a set of neuron models such as a tempotrons (i.e. a neuron or neuron model that can learn spike timing based decision making). According to further embodiments of the present invention, the tempotrons may be conductance based tempotrons. According to a more specific embodiment of the present invention, conductance based tempotrons may be applied to the TI46 isolated digits speech recognition task. Using a simple model of the auditory periphery, sound signals may be converted into patterns of events by thresholding their spatiotemporally filtered power-spectral densities (i.e. “spatiotemporally characterized”) and fed into a small population of conductance-based tempotrons neurons, each of which is trained or otherwise associated with a different word or phoneme.

Each neuron model may be trained or otherwise associated/correlated with a pulse pattern related to a specific phoneme or to an entire word utterance. And, according to some embodiments of the present invention, the word associated with the first, or substantially the first, neuron model to be triggered as a result of receiving the pulses may be designated the recognized word. In cases where the recognition/readout elements are associated with phonemes, a subsequent word recognition stage may be used to correlate identified phonemes with specific words.

Spatiotemporal characterization of an utterance according to some embodiments of the present invention may include detecting energy level crossings across each of a set of predefined energy levels within each of a set of predefined frequency bands. According to further embodiments of the present invention, the energy level within each of the set of frequency bands may be dynamically determined based on the overall energy within the band or the overall energy within the signal, or based on any other method known today or to be devised in the future. Detection of each of the energy level crossings within each of the frequency bands may be performed using either analog or frequency filtering. According to embodiments of the present invention an analog signal representing the speech utterance may be passed in parallel over or through a filter bank including a set of analog band-pass filters, wherein each filter in the set is adapted to only pass frequency components of the signal within a predefined band of frequencies. The output of each of the filters may be monitored by a signal energy detector adapted to receive the output of the filter and to output a pulse on a given output line each time the instantaneous energy level of the input signal crosses a predefined energy level associated with the given output line. If, for example, the detector is configured to detect ten predefined energy level crossings, it may also include ten output lines, such that detection of a crossing of each of the ten energy levels triggers an output pulse on a separate one of the ten output lines, where each specific output line is associated with a specific crossing level. According to further embodiments of the present invention, the detector receiving the output of a given filter may include two output lines associated with some or all of its predefined energy level crossings, such that a pulse is triggered on a first of the two output lines when there is an upward crossing of the predefined level, and a pulse is triggered on a second of the two output lines when there is a downward crossing of the predefined level. Thus, if for example, according to an embodiment of the present invention a speech signal were spectrally characterized using ten band pass filters and ten energy detectors, each of which is adapted to detect ten separate energy level crossings, there would be one hundred output lines according to a scenario where each crossing on each detector is associated with a single output line, and two hundred output lines in the scenario where each crossing on each detector is associated with two output lines (e.g. an upward crossing line and a downward crossing line).

It should be understood by one or ordinary skill in the art that both the filters and the detectors can be implement according to one of numerous techniques known today or to be devised in the future. According to some embodiments of the present invention, any combination of filters and detectors can be integrated into a single circuit or device.

Spectral characterization of a speech utterance signal according to some embodiments of the present invention may also be achieved digitally. For Example, a speech utterance signal may be sampled, by for example an analog to digital converter (“A/D”). Alternatively, the source of the speech signal may be a digitally stored file. The data stream output of the A/D or the digital file (i.e. digital speech signal), representing the speech signal as set of values, may be spectrally decomposed to determine frequency components (e.g. energy levels) at different frequency bands using any of the known techniques, including passing the data stream, in parallel through, a digital filter bank including a set of digital band-pass filters (e.g. Field Programmable Gate Array—FPGA), wherein each filter in the set is adapted to only pass frequency components of the digital signal only within a predefined band of frequencies. The output of each of the digital filters may be monitored by a signal energy detector adapted to receive the output of the filter and to output a pulse on a given output line each time the instantaneous energy level of the input signal crosses a predefined energy level associated with the given output line. If, for example, the detector is configured to detect ten predefined energy level crossings, it may also include ten output lines, such that detection of a crossing of each of the ten energy levels triggers an output pulse on a separate one of the ten output lines, where each specific output line is associated with a specific crossing level. According to further embodiments of the present invention, the detector receiving the output of a given filter may include two output lines associated with some or all of its predefined energy level crossings, such that a pulse is triggered on a first of the two output lines when there is upward crossing of the predefined level, and a pulse is triggered on a second of the two output lines when there is a downward crossing of the predefined level. Thus, if for example, according to an embodiment of the present invention a speech signal were spectrally characterized using ten band pass filters and ten energy detectors, each of which is adapted to detect ten separate energy level crossings, there would be one hundred output lines according to a scenario where each crossing on each detector is associated with a single output line, and two hundred output lines in the scenario where each crossing on each detector is associated with two output lines (e.g. an upward crossing line and a downward crossing line).

Alternatively, the digital filters and the detectors can be implemented in software running on a single processor or across a set of interconnected processors (e.g. General Purpose Processors or Digital Signal Processors). For example, a Fourier or Fast Fourier Transform (“FFT”) may be performed on portions of the digital time domain signal, using a sliding sample window, to produce a set of corresponding frequency domain windows—each of which including a set of values where each value represents an amplitude levels of a discrete frequency components in the digital speech signal. It is known how to calculate in software an instantaneous energy level of a given frequency band of a digital signal based on an FFT of the digital signal. There are also known programming techniques to track a set of values (e.g. calculated energy level) across multiple FFT windows and to trigger a specific event (i.e. a software version of a pulse on a given output line) associated with a specific crossing by the set of values of a predefined value. Thus, it should be clear to one or ordinary skill in the art that any suitable digital processing techniques, known today or to be devised in the future, may be combined to perform spectral characterization according to some embodiments of the present invention may be achieved digitally using.

According to further embodiments of the present invention, any crossing of any value of a derivate (first, second, third, etc.) of an energy level related parameter (e.g. power spectrum density) within each of the frequency bands may be defined as a separate event. It should be understood that the reaching or crossing of any value (predefined or dynamically defined based on the signal characteristics) calculated as any arithmetic combination of a signal energy parameter, and/or its derivates, in a single frequency band or across multiple frequency bands, may be defined as an event for the purposes of the present invention. The number of possible combinations and permutations of derived values is infinite and one or ordinary skill in the art of signal processing should understand that any such combination or permutation may be applicable to the present invention. Each event, regardless of its possible definition, may be associated with a separate spike or pulse line.

According to some embodiments of the present invention, a neuron model such as a tempotron or a conductance based tempotron may be trained or otherwise associated by adjusting a weighting factor associated with each of the pulse (impulse) lines feeding into the neuron model. The set of weighting factors for each neuron model, wherein a neuron model is correlated with a specific phoneme or word, may be determined or selected based on speech samples of the given word.

According to some embodiments of the present invention, a conductance-based time-resealing mechanism may be based on the biophysical property of neurons that their effective integration time may be shaped by synaptic conductances and may be modulated by the firing rate of afferents. To utilize these modulations for time-warp invariant processing, there may be a large evoked total synaptic conductance that dominates the effective integration time constant of the post-synaptic cell through shunting. Large synaptic conductances with a median value of a threefold leak conductance across all digit detector neurons may result from a combination of excitatory and inhibitory inputs.

A large total synaptic conductance is associated with a substantial reduction in a neuron's effective integration time relative to its resting value. Therefore, the resting membrane time constant of a neuron that implements the automatic time resealing mechanism may substantially exceed the temporal resolution that is required by a given recognition or identification task. Because the word recognition tasks may comprise whole word stimuli that favored effective time constants on the order of several tens-of-milliseconds, a resting membrane time constant of Tₘ=100 ms may be used.

To utilize synaptic conductances as efficient controls of the neuron's clock, the peak synaptic conductances may be plastic so as to adjust to the range of integration times relevant for a given perceptual recognition task. This may be achieved using a supervised spike-based learning rule. This plasticity posits that the temporal window during which pre and post-synaptic activity interact, continuously adapts to the effective integration time of the post-synaptic cell. The polarity of synaptic changes may be determined by a supervisory signal that may be realized through neuromodulatory control. According to further embodiments of the present invention, a supervised spike-based learning rule adjusts synaptic peak conductances after each error-trial by an amount which reflects each synapse's contribution to the maximum post-synaptic membrane potential, increasing it when the neuron failed to detect a target and decreasing it if the neuron triggered erroneously.

The following is a detailed description of an experiment which may be understood to be an exemplary, non-limiting, embodiment of a method device and system for recognizing patterns in a signal in accordance with some embodiments of the present invention:

### Time-Warp Invariant Neuronal Processing

Fluctuations in the temporal durations of sensory signals constitute a major source of variability within natural stimulus ensembles. The neuronal mechanisms through which sensory systems can stabilize perception against such fluctuations are largely unknown. An intriguing instantiation of such robustness occurs in human speech perception which relies critically on temporal acoustic cues that are embedded in signals with highly variable duration. Across different instances of natural speech auditory cues can undergo temporal warping that ranges from two-fold compression to two-fold dilation without significant perceptual impairment. Here we report that time-warp invariant neuronal processing can be subserved by the shunting action of synaptic conductances which automatically rescales the effective integration time of post-synaptic neurons. We propose a novel spike-based learning rule for synaptic conductances that adjusts the degree of synaptic shunting to the temporal processing requirements of a given task. Applying this general biophysical mechanism to the example of speech processing, we propose a neuronal network model for time-warp invariant word discrimination and demonstrate its excellent performance on a standard benchmark speech recognition task. Our results demonstrate the important functional role of synaptic conductances in spike-based neuronal information processing and learning. The biophysics of temporal integration at neuronal membranes can endow sensory pathways with powerful time-warp invariant computational capabilities.

### Introduction

Robustness of neuronal information processing to temporal warping of natural stimuli poses a difficult computational challenge to the brain [1-7]. This is particularly true for auditory stimuli which often carry perceptually relevant information in fine differences between temporal cues [8, 9]. For instance in speech, perceptual discriminations between consonants often rely on differences in voice onset times, burst durations or durations of spectral transitions [10, 11]. A striking feature of human performance on such tasks is that it is resilient to a large temporal variability in the absolute timing of these cues. Specifically, changes in speaking rate in ongoing natural speech introduce temporal warping of the acoustic signal on a scale of hundreds of milliseconds, encompassing temporal distortions of acoustic cues that range from twofold compression to twofold dilation [12, 13].

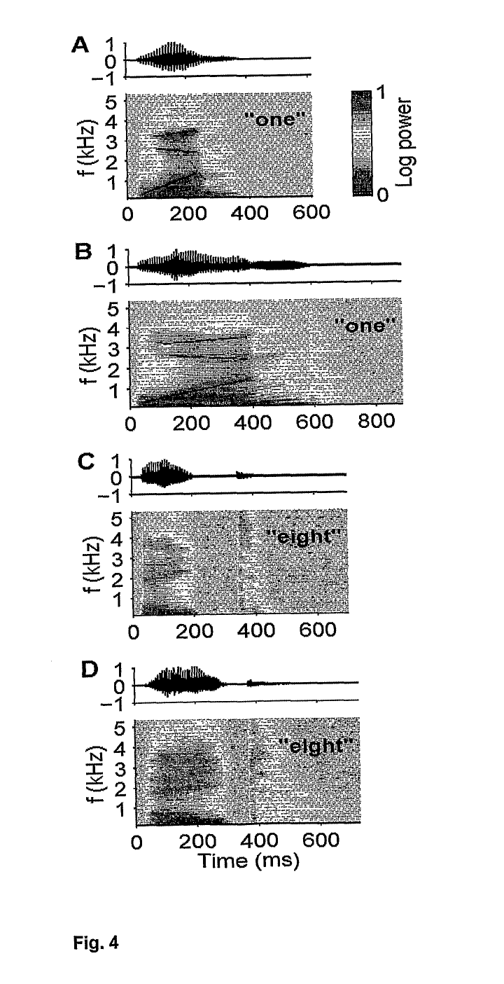

FIG. 4 shows examples of time-warp in natural speech. The utterance of the word “one” in panel A is compressed by nearly a factor of one half relative to the utterance shown in B, causing a con-comitant compression in the duration of prominent spectral features, such as the transitions of the peaks in the frequency spectra. Notably, the pattern of temporal warping in speech can vary within a single utterance on a scale of hundreds of milliseconds. For example, the local time-warp of the word “eight” in panel C relative to D, reverses from compression in the initial and final segments to strong dilation of the gap between them. Although it has long been demonstrated that speech perception in humans normalizes durations of temporal cues to the rate of speech [2, 14-16], the neural mechanisms underlying this perceptual constancy have remained mysterious.

A general solution of the time-warp problem is to undo stimulus rate variations by comodulating the internal “perceptual” clock of a sensory processing system. This clock should run slowly when the rate of the incoming signal is low and embedded temporal cues are dilated but accelerate when the rate is fast and the temporal cues are compressed. Here we propose a neural implementation of this solution, exploiting a basic biophysical property of synaptic inputs, namely that in addition to charging the post-synaptic neuronal membrane, synaptic conductances modulate its effective time constant. To utilize this mechanism for time-warp robust information processing in the context of a particular perceptual task, synaptic peak conductances at the site of temporal cue integration need to be adjusted to match the range of incoming spike rates. We show that such adjustments can be achieved by a novel conductance-based supervised learning rule. We first demonstrate the computational power of the proposed mechanism by testing our neuron model on a synthetic instantiation of a generic time-warp invariant neuronal computation, namely time-warp invariant classification of random spike latency patterns. We then present a novel neuronal network model for word recognition and show that it yields excellent performance on a benchmark speech recognition task, comparable to that achieved by highly elaborate, biologically implausible state-of-the-art speech recognition algorithms.

### Results

### Time Rescaling in Neuronal Circuits

While the net current flow into a neuron is determined by the balance between excitatory and inhibitory synaptic inputs, both types of inputs increase the total synaptic conductance, which in turn modulates the effective integration time of the postsynaptic cell [17-19] (an effect known as synaptic shunting). Specifically, when the total synaptic conductance of a neuron is large relative to the resting conductance (leak) and is generated by linear summation of incoming synaptic events, the neuron's effective integration time scales inversely to the rate of inputs spikes. Hence, the shunting action of synaptic conductances can counter variations in afferent spike rates by automatically rescaling the effective integration time of the post-synaptic neuron.

To perform time-warp invariant tasks, peak synaptic conductances must be in the range of values appropriate for the statistics of the stimulus ensemble of the given task. To achieve this, we have devised a novel spike-based learning rule for synaptic conductances, the conductance-based tem-potron. This model neuron learns to discriminate between two classes of spatio-temporal input spike patterns. The tempotron's classification rule requires it to fire at least one spike in response to each of its target stimuli but to remain silent when driven by a stimulus from the null class. Spike patterns from both classes are iteratively presented to the neuron and peak synaptic conductances are modified following each error trial by an amount proportional to their contribution to the maximum value of the postsynaptic potential over time (Methods). This contribution is sensitive to the time courses of the total conductance and voltage of the post-synaptic neuron. Therefore the conductance-based tempotron learns to adjust not only the magnitude of the synaptic inputs but also its effective integration time to the statistics of the task at hand.

### Learning to Classify Time-Warped Latency Patterns

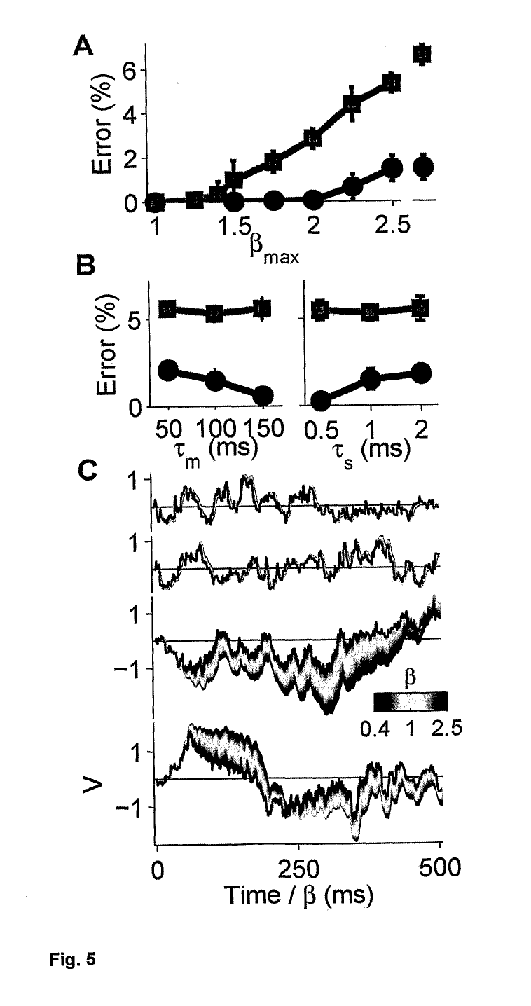

We first quantified the time-warp robustness of the conductance-based tempotron on a synthetic discrimination task. We randomly assigned 1250 spike pattern templates to target and null classes. The templates consisted of 500 afferents, each firing once at a fixed time chosen randomly from a uniform distribution between 0 and 500 ms. Upon each presentation during training and testing, the templates underwent global temporal warping by a random factor β ranging from compression by 1/β max to dilation by β max (Methods). Consistent with the psychophysical range, β max was varied between 1 and 2.5. Remarkably, with physiologically plausible parameters, the error frequency remained almost zero up to βmax≈2 (FIG. 5A, blue curve). Importantly, the performance of the conductance-based tempotron showed little change when the temporal warping applied to the spike templates was dynamic (Methods) (FIG. 5A). The time-warp robustness of the neural classification depends on the resting membrane time constant τ·m and the synaptic time constant τ·s. Increases in τ·m or decreases in τ·s both enhance the dominance of shunting in governing the cell's effective time constant. As a result, the performance for βmax=2.5 improved with increasing τ·m (FIG. 5B, left) and decreasing τ·s (FIG. 5C, right). The time-warp robustness of the conductance-based tempotron was also reflected in the shape of its subthreshold voltage traces (FIG. 5C, top row) and generalized to novel spike templates with the same input statistics that were not used during training (FIG. 5C, second row).

Synaptic conductances were crucial in generating the neuron's robustness to temporal warping. While an analogous neuron model with a fixed integration time, the current-based tempotron [20] (Methods), also performed the task perfectly in the absence of time-warp (βmax=1), its error frequency was sensitive even to modest temporal warping and deteriorated further when the applied time-warp was dynamic (FIG. 5A, red curve). Similarly, the voltage traces of this current-based neuron showed strong dependence on the degree of temporal warping applied to an input spike train (FIG. 5C, bottom trace pair). Finally, the error frequency of the current-based neuron at βmax=2.5 showed only negligible dependence on the values of the membrane and synaptic time constants (FIG. 5B), highlighting the limited capabilities of fixed neural kinetics to subserve timewarp invariant spike-pattern classification.

### Adaptive Plasticity Window

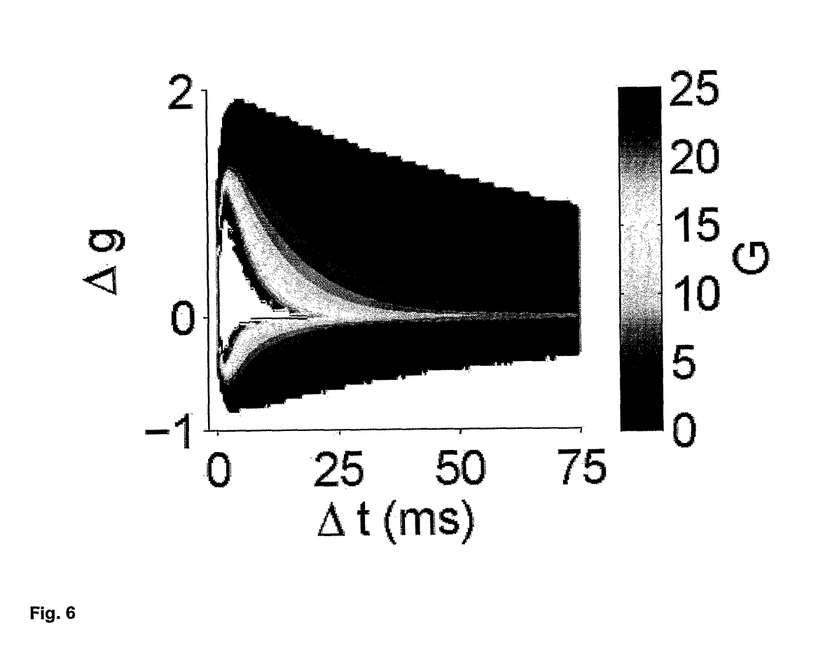

In the conductance-based tempotron, synaptic conductances controlled not only the effective integration time of the neuron but also the temporal selectivity of the synaptic update during learning. The tempotron learning rule modifies only the efficacies of the synapses that were activated in a temporal window prior to the peak in the post-synaptic voltage trace. However, the width of this temporal plasticity window is not fixed but depends on the effective integration time of the post-synaptic neuron at the time of each synaptic update trial, which in turn varies with the input firing rate at each trial and the strength of the peak synaptic conductances at this stage of learning (FIG. 6). During epochs of high conductance (warm colors) only synapses that fired shortly before the voltage maximum were appreciably modified. In contrast, when the membrane conductance was low (cool colors), the plasticity window was broad.

### Task Dependence of Learned Synaptic Conductance

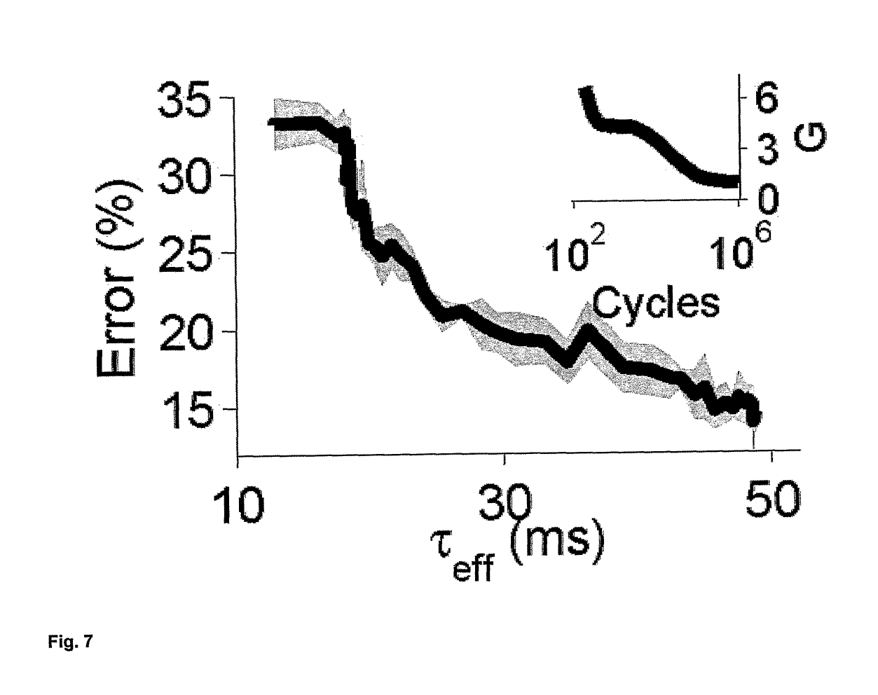

The evolution of synaptic peak conductances during learning was driven by task requirements. When we replaced the temporal warping of the spike templates by random Gaussian jitter [20] (Methods), conductance-based tempotrons that had acquired high synaptic peak conductances during initial training on the time-warp task readjusted their synaptic peak conductances to low values (FIG. 7, inset). The concomitant increase in their effective integration time constants from roughly 10 ms to 50 ms improved the neurons' ability to average out the temporal spike jitter and substantially enhanced their task performance (FIG. 7).

### Neuronal Model of Word Recognition

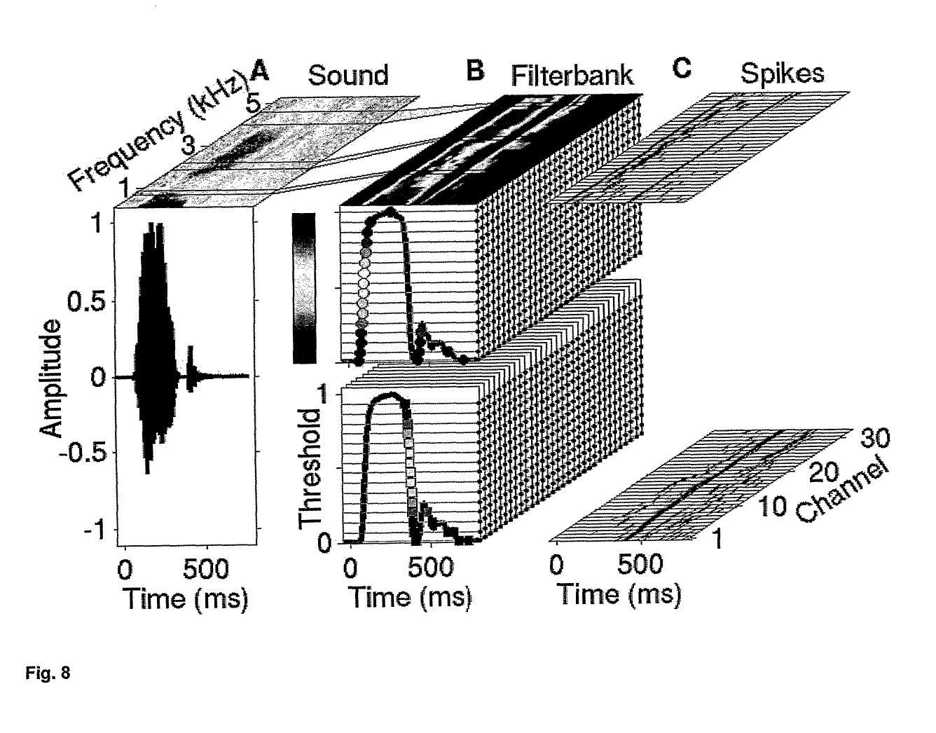

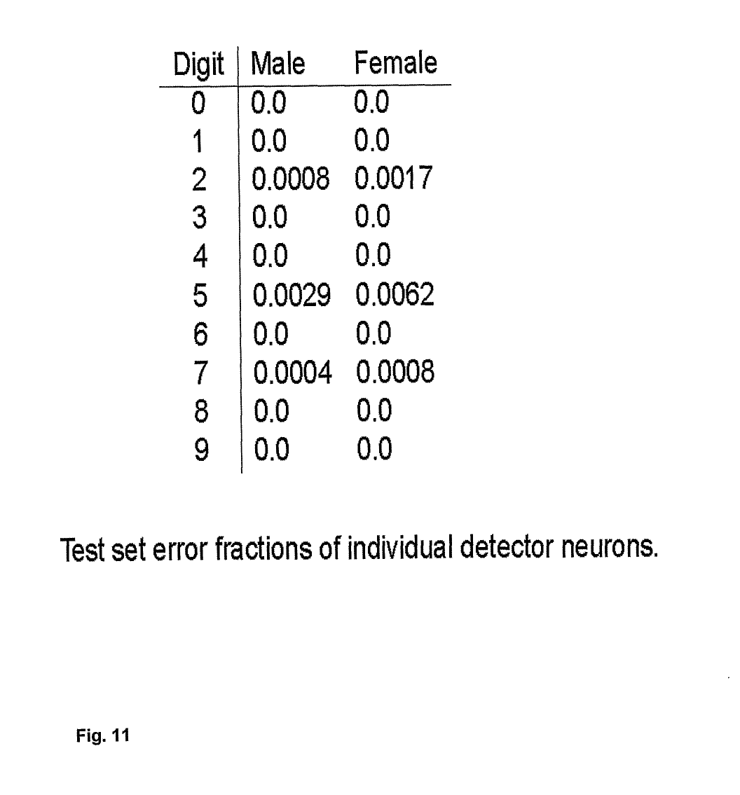

To address time-warp invariant speech processing we studied a neuronal module that learns to perform word recognition tasks. Our model consists of two auditory processing stages. The first stage (FIG. 8) consists of an afferent population of neurons that convert incoming acoustic signals into spike patterns by encoding the occurrences of elementary spectro-temporal events. This layer forms a two dimensional tonotopy-intensity auditory map. Each of its afferents generates spikes by performing an onset or offset threshold operation on the power of the acoustic signal in a given frequency band. Whereas an onset afferent elicits a spike whenever the log signal power crosses its threshold level from below, offset afferents encode the occurrences of downward crossings (Methods) (cf also refs. [5, 21]). Different on and off neurons coding for the same frequency band differ in their threshold value, reflecting a systematic variation in their intensity tuning. The second, downstream, layer consists of neurons with plastic synaptic peak conductances that are governed by the conductance-based tempotron plasticity rule. These neurons are trained to perform word discrimination tasks. We tested this model on a digit recognition benchmark task with the TI46 database [22]. We trained each of the 20 conductance-based tempotrons of the second layer to perform a distinct gender-specific binary classification, requiring it to fire in response to utterances of one digit and speaker gender, and to remain quiescent for all other stimuli. After training, the majority of these digit detector neurons (70%) achieved perfect classification of the test set and the remaining ones performed their task with a low error (FIG. 11). Based on the spiking activity of this small population of digit detector neurons, a full digit classifier (Methods) that weighted spikes according to each detector's individual performance, achieved an overall word error rate of 0.0017. This performance matches the error of state-of-the-art artificial speech recognition systems such as the Hidden Markov model based Sphinx-4 on the same benchmark [23].

### Learned Spectro-Temporal Target Features

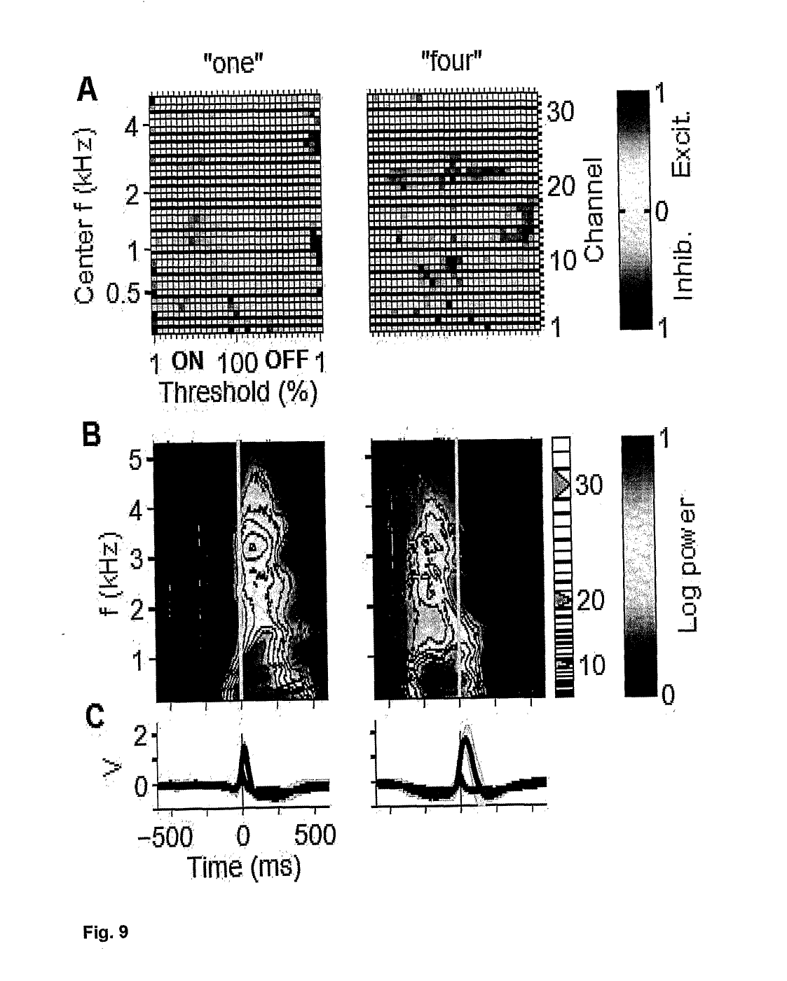

To reveal the mean spectro-temporal target features encoded by the learned synaptic distributions (FIG. 9A) of the individual digit detector neurons, we averaged the spectrograms of a neuron's target stimuli aligned to the time of its output spikes (FIG. 9B; Methods). The spectro-temporal features that preceeded the output spikes (time zero, grey vertical lines) corresponded to the frequency specific onset and offset selectivity of the excitatory afferents (FIG. 9A, warm colors). For instance, the gradual onset of power across the lower frequency range (FIG. 9B, left, channels 1-16) underlying the detection of the word “one” (male speakers) was encoded by a diagonal band of excitatory onset afferents whose thresholds decreased with increasing frequency (FIG. 9A, left). By compensating for the temporal lag between the lower frequency channels, this arrangement ensured a strong excitatory drive when a target stimulus was presented to the neuron. The spectrotemporal feature learned by the word “four” (male speakers) detector neuron combined decreasing power in the low frequency range with rising power in the mid frequency range (FIG. 9B, right). This feature was encoded by synaptic efficacies through a combination of excitatory offset afferents in the low frequency range (FIG. 9A, right, channels 1-11) and excitatory onset afferents in the mid frequency range (channels 12-19). Excitatory synaptic populations were complemented by inhibitory inputs (FIG. 9A, blue patches) that prevented spiking in response to null stimuli and also increased the total synaptic conductance. The substantial differences between the mean spike triggered voltage traces for target stimuli (FIG. 9C, blue) and the mean maximum triggered voltage traces for null stimuli (red) underline the high target word selectivity of the learned synaptic distributions as well as the relatively short temporal extent of the learned target features.

Note that in the examples shown, the average position of the neural decision relative to the target stimuli varied from early to late (FIG. 9B, left vs. right). This important degree of freedom stems from the fact that the tempotron decision rule does not constrain the time of the neural decision. As a result, the learning process in each neuron can select the spectro-temporal target features from anywhere within the target word. This choice comprises a central component of the solution to a given classification task; implementing the combined requirement of triggering spikes during target stimuli but not during null stimuli, it reflects the statistics of both, the target and the null stimuli.

### Time-Warp Robustness

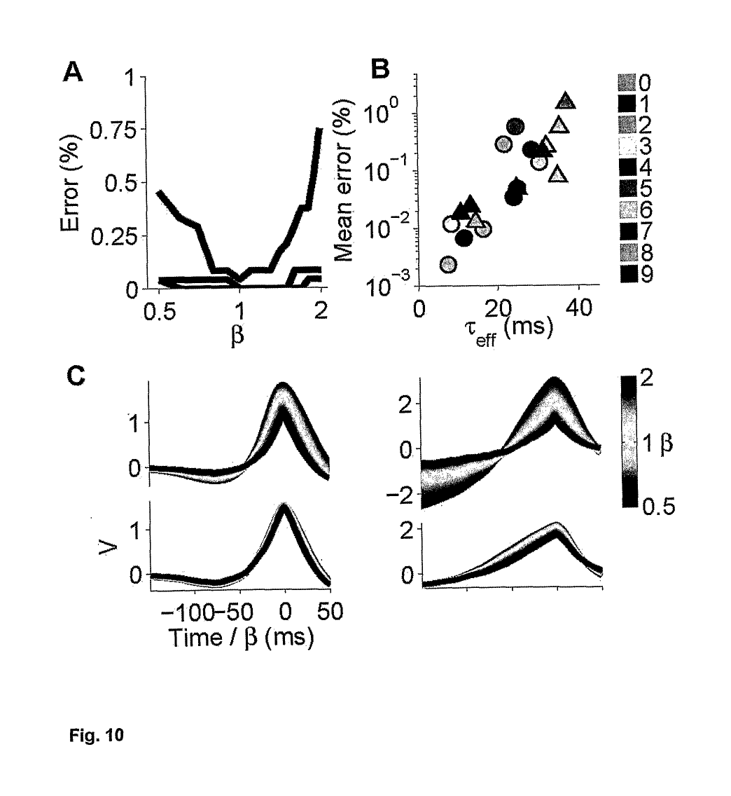

Our model neurons exhibited considerable time-warp robust performance on the digit recognition task. For instance, the errors for the “one” (FIG. 10A, black line) and “four” (blue line) detector neurons (cf. FIG. 9) were insensitive to a twofold time-warp of the input spike trains. The “seven” detector neuron (male, red line) showed higher sensitivity to such warping; nevertheless its error rate remained low. Consistent with the proposed role of synaptic conductances, the degree of time-warp robustness was correlated with the total synaptic conductance, here quantified through the mean effective integration time τ·eff (FIG. 10B). Additionally, the mean voltage traces induced by the target stimuli (FIG. 10C, lower traces) showed a substantially smaller sensitivity to temporalwarping than their current-based analogs (Methods) (FIG. 10C, upper traces).

### Discussion

### Automatic Resealing of Effective Integration Time by Synaptic Conductances

The proposed conductance-based time-rescaling mechanism is based on the biophysical property of neurons that their effective integration time is shaped by synaptic conductances and therefore can be modulated by the firing rate of its afferents. To utilize these modulations for time-warp invariant processing a central requirement is a large evoked total synaptic conductance, that dominates the effective integration time constant of the post-synaptic cell through shunting. In our speech processing model, large synaptic conductances with a median value of a threefold leak conductance across all digit detector neurons (cf. FIG. 10B), result from a combination of excitatory and inhibitory inputs. This is consistent with high total synaptic conductances, comprising excitation and inhibition, that have been observed in several regions of cortex [24] including auditory [25, 26], visual [27, 28] and also prefrontal [29, 30] (but see ref. [31]).

A large total synaptic conductance is associated with a substantial reduction in a neuron's effective integration time relative to its resting value. Therefore, the resting membrane time constant of a neuron that implements the automatic time resealing mechanism must substantially exceed the temporal resolution that is required by a given processing task. Because the word recognition benchmark task used here comprises whole word stimuli that favored effective time constants on the order of several tens-of-milliseconds we used a resting membrane time constant of τ·m=100 ms. While values of this order have been reported in hippocampus [32] and cerebellum [19, 33] it exceeds current estimates for neo-cortical neurons which range between 10-30 ms [31, 34, 35]. Note, however, that the correspondence of our passive membrane model and the experimental values that typically include contributions from various voltage-dependent conductances is not straightforward. Our model predicts that neurons specialized for time warp invariant processing at the whole word level have relatively long resting membrane time constants. It is likely that the auditory system solves the problem of time-warp invariant processing of the sound signal primarily at the level of shorter speech segments such as phonemes. This is supported by evidence that primary auditory cortex has a special role in speech processing at a resolution of milliseconds to tens-of-milliseconds [9-11]. Our mechanism would enable time-warp invariant processing of phonetic segments with resting membrane time constants in the range of tens-of-milliseconds, and much shorter effective integration times.

### Supervised Learning of Synaptic Conductances

To utilize synaptic conductances as efficient controls of the neuron's clock the peak synaptic conductances must be plastic so that they adjust to the range of integration times relevant for a given perceptual task. This was achieved in our model by our novel supervised spike-based learning rule. This plasticity posits that the temporal window during which pre and post-synaptic activity interact, continuously adapts to the effective integration time of the post-synaptic cell (FIG. 6). The polarity of synaptic changes is determined by a supervisory signal, that we hypothesize to be realized through neuromodulatory control [20]. Because present experimental measurements of spike-timing dependent synaptic plasticity rules have assumed an unsupervised setting, i.e. have not controlled for neuromodulatory signals (but see [36]), existing results do not directly apply to our model. Nevertheless, recent data have revealed complex interactions between the statistics of pre and post-synaptic spiking activity and the expression of synaptic changes [37-40]. Our model offers a novel computational rationale for such interactions, predicting that for fixed supervisory signaling the temporal window of plasticity shrinks with growing levels of post-synaptic shunting. By extending the approach developed in ref. [20], we have checked (not shown) that the global computation required by the proposed learning rule for evaluating a synapse's contribution to the maximal post-synaptic voltage can be approximated by a temporally local biologically feasible convolution-based estimator that captures the correlation between the pre-synaptic activity and the post-synaptic voltage trace.

### Time-Warp Invariance is Task Dependent

In our model, dynamic time-warp invariant capabilities become available through a conductance based learning rule that tunes the shunting action of synaptic conductances. This learning rule enables neurons to adjust the degree of synaptic shunting to the requirements of a given processing task. As a result, our model can naturally encompass a continuum of functional specializations ranging from neurons that are sensitive to absolute stimulus durations by employing low total synaptic conductances to time-warp invariant feature detectors that operate in a high-conductance regime. In the context of auditory processing, such a functional segregation into neurons with slower and faster effective integration times is reminiscent of reports suggesting that rapid temporal processing in time frames of tens of milliseconds is localized in left lateralized language areas whereas processing of slower temporal features is attributed to right hemispheric areas [41-43]. Although anatomical and morphological asymmetries between left and right human auditory cortices are well documented [44], it remains to be seen whether these differences form the physiological substrate for a left lateralized implementation of the proposed time resealing mechanism. Consistent with this picture, the general tradeoff between high temporal resolution and robustness to temporal jitter that is predicted by our model (FIG. 7), parallels reports of the vulnerability of the lateralizion of language processing with respect to background acoustic noise [45] as well as to abnormal timing of auditory brainstem responses [46].

### Neuronal Circuitry for Time-Warp Invariant Feature Detection

The architecture of our speech processing model encompasses two auditory processing stages. The first stage transforms acoustic signals into spatio-temporal patterns of spikes. To engage the proposed automatic time resealing mechanism, the rate of spikes elicited in this afferent layer must track variations in the rate of incoming speech. Such behavior emerges naturally in a sparse coding scheme in which each neuron responds transiently to the occurrences of a specific acoustic event within the auditory input. As a result, variations in the rate of acoustic events are directly translated into concomitant variations in the rate of elicited spikes. In our model the elementary acoustic events correspond to onset and offset threshold crossings of signal power within specific frequency channels. Such frequency tuned onset and offset responses featuring a wide range of dynamic thresholds have been observed in the inferior colliculus (IC) of the auditory midbrain [47]. This nucleus is the site of convergence of projections from the majority of lower auditory nuclei and is often referred to as the interface between the lower brain stem auditory pathways and the auditory cortex. Correspondingly, we hypothesize that the layer of time-warp invariant feature detector neurons in our model implements neurons located downstream of the IC, most probably in primary auditory cortex. Current studies on the functional role of the auditory periphery in speech perception and its pathologies have been limited by the lack of biologically plausible neuronal readout architectures; a limitation overcome by our model, which allows evaluation of specific components of the auditory pathway in a functional context.

### Implications for Speech Processing

Psychoacoustic studies have indicated that the neural mechanism underlying the perceptual normalization of temporal speech cues is involuntary, i.e. it is cognitively impenetrable [14], controlled by physical rather than perceived speaking rate [15], confined to a temporally local context [2, 16], not specific to speech sounds [48], and operational already in pre-articulate infants [49]. The proposed conductance-based time-rescaling mechanism is consistent with these constraints. Moreover, our model posits a direct functional relation between high synaptic conductances and the time-warp robustness of human speech perception. This relation gives rise to a novel mechanistic hypothesis explaining the impaired capabilities of elderly listeners to process time-compressed speech [50, 51]. We hypothesize that the downregulation of inhibitory neurotransmitter systems in aging mammalian auditory pathways [52, 53] limits the total synaptic conductance and therefore prevents the time rescaling mechanism from generating short effective time constants through synaptic shunting. Furthermore our model implies that comprehension deficits in older adults should be linked specifically to the processing of phonetic segments that contain fast time-compressed temporal cues. Our hypothesis is consistent with two interrelated lines of evidence. First, comprehension difficulties of time-compressed speech in older adults are more likely a consequence of an age-related decline in central auditory processing than attributes of a general cognitive slowing [52, 54]. Second, recent reports have indicated that recognition differences between young and elderly listeners originate mainly from the temporal compression of consonants, which often feature rapid spectral transitions, but not from steady-state segments [50, 51, 54] of speech. Finally, our hypothesis posits that speaking rate induced shifts in perceptual category boundaries [2, 14, 15] should be age dependent, i.e. their magnitude should decrease with increasing listener age. This prediction is straightforwardly testable within established psychoacoustic paradigms.

### Connections to Other Models of Time-Warp Invariant Processing

In a previous neuronal model of time-warp invariant speech processing [5], sequences of acoustic events are converted into patterns of transient spike synchrony which depend only on the relative timing of the events but not on the absolute duration of the auditory signal. One disadvantage of this approach is that it copes only with global (uniform) temporal warping. Invariant processing of dynamic time-warp as is exhibited by natural speech (cf. FIGS. 4C and D) is more challenging since it requires robustness to local temporal distortions of a certain statistical character. Established algorithms that can cope with dynamically time-warped signals are typically based on minimizing the deviation between an observed signal and a stored reference template [55-57]. These algorithms are computationally expensive and lack biologically plausible neuronal implementations. By contrast, our conductance-based time-rescaling mechanism results naturally from the biophysical properties of input integration at the neuronal membrane and does not require dedicated computational resources. Importantly, our model does not rely on a comparison between the incoming signal and a stored reference template. Rather, after synaptic conductances have adjusted to the statistics of a given stimulus ensemble, the mechanism generalizes and automatically stabilizes neuronal voltage responses against dynamic time-warp even when processing novel stimuli (cf. FIG. 5C). The architecture of our neuronal model also fundamentally departs from the decade sold layout of Hidden Markov Model based artificial speech recognition systems, which employ probabilistic models of state sequences. These systems are hard to reconcile with the biological reality of neuronal system architecture, dynamics and plasticity. The similarity in performance between our model and such state-of-the-art systems, on a small vocabulary task highlights the powerful processing capabilities of spike-based neural representations and computation.

### Generality of Mechanism

Although the present work focuses on the concrete and well documented example of time-warp robustness in the context of neural speech processing, the proposed mechanism of automatic resealing of integration time is general and applies also to other problems of neuronal temporal processing such as birdsong recognition [3], insect communication [7] and other ethologically important natural auditory signals. Moreover, robustness of neuronal processing to temporal distortions of spike patterns is not only important for the processing of stimulus time dependencies but also in the context of spike-timing based neuronal codes where the precise temporal structure of spiking activity encodes information about non-temporal physical stimulus dimensions [58]. Evidence for such temporal neural codes have been reported in the visual [59-61], auditory [62], somatosensory [63] as well as olfactory [64] pathways. As a result we expect mechanisms of time-warp invariant processing to also play a role in generating perceptual constancies along non-temporal stimulus dimensions such as contrast invariance in vision or concentration invariance in olfaction [4]. Finally, time-warp has also been described in intrinsically generated brain signals. Specifically, the replay of hippocampal and cortical spiking activity at variable temporal warping [65, 66] suggests that our model has applicability beyond sensory processing, possibly also encompassing memory storage and retrieval.

### Materials and Methods

### Conductance-Based Neuronmodel.

Numerical simulations of the conductance-based tempotron were based on exact integration [67] of the voltage dynamics of a leaky integrate-and-fire neuron driven by exponentially decaying synaptic conductances gᵢ(t)=gᵢ^{max}exp(−t/τₛ). Here, gᵢ^{max}(i=1, . . . , N) denotes the plastic peak conductance of the ith synapse in units of the neurons leak conductance and τ·s is the synaptic time constant. Denoting by tᵢ^{j} the arrival time of the jth spike of the ith afferent, the total synaptic conductance at time t is given by G(t)=Σᵢ₌₁^{N}Σₜ_{ᵢ}_{^{j}}_{<t}gᵢ(t−tᵢ^{j}). Analogously, the total synaptic input current is E(t)=Σᵢ₌₁^{N}Σₜ_{ᵢ}^{ⱼ}_{<t}Vᵢ^{rev}gᵢ(t−tᵢ^{j}), where Vᵢ^{rev} denotes the reversal potential of the ith synapse. The resulting membrane potential dynamics is

$${τ}_{m} \frac{d}{d t} V ( t ) = - V ( t ) ( 1 + G ( t ) ) + E ( t ) .$$

An output spike was elicited when V(t) crossed the firing threshold Vₜₕᵣ. After a spike at tₛₚᵢₖₑ, the voltage is smoothly reset to the resting value by shunting all synaptic inputs that arrive after tₛₚᵢₖₑ (cf. ref. [20]). We used Vₜₕᵣ=1 and Vᵣₑₛₜ=0 and reversal potentials Vₑₓ^{rev}=5 and Vᵢₙ^{rev}=−1 for excitatory and inhibitory conductances, respectively. The resting membrane time constant [18] was set to τ·m=100 ms throughout our work. For the synaptic time constant we used τ·s=1 ms for the random latency task (minimizing the error of the current-based neuron) and to τ·s=5 ms in the speech recognition tasks. The effective integration time was defined by τ_{eff}(t)=τₘ/(1+G(t)), where G(t) denotes the total synaptic conductance in units of the leak conductance.

### Tempotron Learning.

Following ref. [20], changes in the synaptic peak conductance gᵢ^{max} of the ith synapse after an error trial were given by the gradient of the post-synaptic potential, Δgᵢ^{max}∝−dV(tₘₐₓ)/dgᵢ^{max}, at the time of its maximal value tₘₐₓ. To compute the synaptic update for a given error trial, the exact solution of Eq. (1) was differentiated with respect to gᵢ^{max} and evaluated at tₘₐₓ which was determined numerically.

### Global Time-Warp.

Global time-warp was implemented by multiplying all firing times of a spike template by a constant scaling factor β. In FIG. 5A, random global time-warp between compression by 1/βmax and dilation by βmax was generated by setting β=exp(q ln(βₘₐₓ)) with q drawn from a uniform distribution between −1 and 1 for each presentation.

### Dynamic Time-Warp.

Dynamic time-warp was implemented by scaling successive inter spike intervals tⱼ−tⱼ₋₁ of a given template with a time dependent warping factor \tilde{β}(t), such that warped spike times t′ⱼ=t′ⱼ₋₁+\tilde{β}(tⱼ)(tⱼ−tⱼ₋₁) with t′₁≡t₁ and \tilde{β}(t)=exp(\tilde{q}(t)ln(βₘₐₓ)). The time dependent factor \tilde{q}(t)=erfc(ξ(t))−1 resulted from an equilibrated Ornstein-Uhlenbeck process ξ(t) with a relaxation time of τ=200 ms that was resealed by the complementary Error function erfc to transform the normal distribution of τ(t) into a uniform distribution over [−1 1] at each t.

### Current-Based Neuron Model.

In the current based tempotron which was implemented as described in ref. [20], each input spike evoked an exponentially decaying synaptic current that gave rise to a post-synaptic potential with a fixed temporal profile. In FIG. 10C (upper row), voltage traces of a current-based analog of a conductance-based tempotron with learned synaptic conductances g₁^{max}, reversal potentials Vᵢ^{rev} and effective membrane integration time τ·eff (cf. FIG. 10B) were computed by setting the synaptic efficacies ωᵢ of the current-based neuron to ωᵢ=gᵢ^{max}Vᵢ^{rev} and its membrane time constant to τ·m=τ·eff. The resulting current-based voltage traces were scaled such that for each pair of models the mean voltage maxima for unwarped stimuli (β=1) were equal.

### Gaussian Spike Time Jitter.

Spike time jitter [20] was implemented by adding independent Gaussian noise with zero mean and a standard deviation of 5 ms to each spike of a template before each presentation.

### Acoustic Front-End.

Sound signals were normalized to unit peak amplitude and converted into spectrograms over NFFT=129 linearly spaced frequencies fj=fmin+j(fmax−fmin)/(NFFT+1)(j=1 . . . NFFT) between fmin=130 Hz and fmax=5400 Hz by a sliding fast Fourier transform with a window size of 256 samples and a temporal step size of 1 ms. The resulting spectrograms were filtered into Nf=32 logarithmically spaced Mel frequency channels by overlapping triangular frequency kernels. Specifically, Nf+2 linearly spaced frequencies given by hj=hmin+j(hmax−hmin)/(Nf+1) with j=0 . . . Nf+1 and hmax, min=2595 log(1+fmax,min/700) were transformed to a Mel frequency scale fⱼ^{Mel}=700(exp(hⱼ/2595)−1) between fmin and fmax. Based on these, signals in Nf channels resulted from triangular frequency filters over intervals [fⱼ₋₁^{Mel}, fⱼ₊₁^{Mel}] with center peaks at fⱼ^{Mel} (j=1 . . . N_{f}). After normalization of the resulting Mel-spectrogram S^{Mel} to unit peak amplitude, the logarithm was taken through log(S^{Mel}+ε)−log(ε) with ε=10⁻⁵ and the signal in each frequency channel smoothed in time by a Gaussian kernel with a time constant of 10 ms. Spikes were generated by thresholding of the resulting signals by a total of 31 onset and offset threshold crossing detector units. While each onset afferent emitted a spike whenever the signal crossed its threshold in the upward direction, offset afferents fired when the signal dropped below the threshold from above. For each frequency channel and each utterance, threshold levels for onset and offset afferents were set relative to the maximum signal over time to σ₁=0.01 and σⱼ=j/15 (j=1 . . . 15). For σ₁₅=1, onset and offset afferents were reduced to a single afferent whose spikes encoded the time of the maximum signal for a given frequency channel.

### Digit Classification.

Based on the spiking activity of all binary digit detector neurons, a full digit classifier was implemented by ranking the digit detectors according to their individual task performances. As a result, a given stimulus was classified as the target digit of the most reliable of all responding digit detector neurons. If all neurons remained silent, a stimulus was classified as the target digit of the least reliable neuron.

### Spike-Triggered Target Features.

To preserve the timing relations between the learned spectro-temporal features and the target words, we refrained from correcting the spike triggered stimuli for stimulus autocorrelations [68].

### Learning Rate and Momentum Term.

As in ref. [20] we employed a momentum heuristic to accelerate learning in all learning rules. In this scheme synaptic updates consisted not only of the correction λΔgᵢ^{max} which was given by the learning rule and the learning rate λ but also incorporated a fraction μ of the previous synaptic change [Δgᵢ^{max}]ₚᵣₑᵥᵢₒᵤₛ. Hence, [Δgᵢ^{max}]_{current}=λΔgᵢ^{max}_{+μ[Δg}^{max}]ₚᵣₑᵥᵢₒᵤₛ. We used an adaptive learning rate that decreased from its initial value λini as the number of learning cycles 1 grew, λ=λᵢₙᵢ/(1+10⁻⁴(l−1)). A learning cycle corresponded to one iteration through the batch of templates in the random latency task or the training set in the speech task.

### Random Latency Task Training.

To ensure a fair comparison between the conductance-based and the current-based tempotrons (cf. FIG. 5A), the learning rule parameters λini and μ were optimized for each model. Specifically, for each value of βmax optimal values over a two dimensional grid were determined by the minimal error frequency achieved during runs over 10⁵ cycles with synaptic efficacies starting from Gaussian distributions with zero mean and standard deviations of 0.001. The optimization was performed over five realizations.

### Speech Task Training.

Test errors in the speech tasks were substantially reduced by training with a Gaussian spike jitter with a standard deviation of σ added to the input spikes as well a symmetric threshold margin ν that required the maximum post-synaptic voltage on target stimuli to exceed Vₜₕᵣ+ν and to remain below Vₜₕᵣ−ν during null stimuli. Values of λini, μ, σ and β were optimized on a four dimensional grid. Because for each grid point only short runs over maximally 200 cycles were performed, we also varied the mean values of initial Gaussian distributions of the excitatory and inhibitory synaptic peak conductances, keeping their standard deviations fixed at 0.001. The reported performances are based on the solutions that had the smallest errors fractions over the test set. If not unique, we selected the solution with the highest robustness to time-warp (cf. FIG. 10B).

### RELATED DOCUMENTS

The below referenced documents, relate to and support the subject matter of the present patent application, these documents are hereby incorporated in their entirety.
1. Sakoe H, Chiba S (1978) Dynamic programming algorithm optimization for spoken word recognition. IEEE Acoust Speech Signal Process Mag ASSP-26:43-49.
2. Miller J L (1981) Effects of speaking rate on segmental distinctions. In: Eimas P D, Miller J L, editors, Perspectives on the Study of Speech. Hilsdale, New Jersey: Lawrence Erlbaum Associates, pp. 39-74.
3. Anderson S, Dave A, Margoliash D (1996) Template-based automatic recognition of birdsong syllables from continuous recordings. J Acoust Soc Am 100:1209-19.
4. Hopfield J (1996) Transforming neural computations and representing time. Proc Natl Acad Sci USA 93:15440-15444.
5. Hopfield J J, Brody C D (2001) What is a moment? transient synchrony as a collective mechanism for spatiotemporal integration. Proc Natl Acad Sci USA 98:1282-1287.
6. Brown J, Miller P (2007) Automatic classification of killer whale vocalizations using dynamic time warping. J Acoust Soc Am 122:1201-1207.
7. Gollisch T (2008) Time-warp invariant pattern detection with bursting neurons. New J Phys 10:015012.
8. Shannon R, Zeng F, Kamath V, Wygonski J, Ekelid M (1995) Speech recognition with primarily temporal cues. Science 270:303-304.
9. Merzenich M, JenkinsW, Johnston P, Schreiner C, Miller S, et al. (1996) Temporal processing deficits of language-learning impaired children ameliorated by training. Science 271:77-81.
10. Phillips D, Farmer M (1990) Acquired word deafness, and the temporal grain of sound representation in the primary auditory cortex. Behav Brain Res 40:85-94.
11. Fitch R H, Miller S, Tallal P (1997) Neurobiology of speech perception. Annu Rev Neurosci 20:331-351.
12. Miller J L, Grosjean F, Lomanto C (1984) Articulation rate and its variability in spontaneous speech: a reanalysis and some implications. Phonetica 41:215-225.
13. Miller J L, Grosjean F, Lomanto C (1986) Speaking rate and segments: A look at the relation between speech production and speech perception for voicing contrast. Phonetica 43:106-115.
14. Miller J L, Green K, Schermer T M (1984) A distinction between the effects of sentential speaking rate and semantic congruity on word identification. Percept Psychophys 36:329-337.
15. Miller J L, Aibel I L, Green K (1984) On the nature of rate-dependent processing during phonetic perception. Percept Psychophys 35:5-15.
16. Newman R, Sawusch J (1996) Perceptual normalization for speaking rate: effects of temporal distance. Percept Psychophys 58:540-560.
17. Bernander O, Douglas R, Martin K, Koch C (1991) Synaptic background activity influences spatiotemporal integration in single pyramidal cells. Proc Natl Acad Sci USA 88:11569-11573.
18. Koch C, Rapp M, Segev I (1996) A brief history of time (constants). Cereb Cortex 6:93-101.
19. H″ausser M, Clark B A (1997) Tonic synaptic inhibition modulates neuronal output pattern and spatiotemporal synaptic integration. Neuron 19:665-678.
20. G″utig R, Sompolinsky H (2006) The tempotron: a neuron that learns spike timing-based decisions. Nat Neurosci 9:420-428.
21. Hopfield J J (2004) Encoding for computation: recognizing brief dynamical patterns by exploiting effects of weak rhythms on action-potential timing. Proc Natl Acad Sci USA 101:6255-6260.
22. Liberman M, Amsler R, Church K, Fox E, Hafner C, et al. (1993) TI 46-Word. Philadelphia: Linguistic Data Consortium.
23. Walker W, Lamere P, Kwok P, Raj B, Singh R, et al. (2004) Sphinx-4: A flexible open source framework for speech recognition. Technical Report SMLI TR-2005-139, Sun Microsystems Laboratories.
24. Destexhe A, Rudolph M, Par'e D (2003) The high-conductance state of neocortical neurons in vivo. Nat Rev Neurosci 4:739-751.
25. Zhang L, Tan A, Schreiner C, Merzenich M (2003) Topography and synaptic shaping of direction selectivity in primary auditory cortex. Nature 424:201-205.
26. Wehr M, Zador A (2003) Balanced inhibition underlies tuning and sharpens spike timing in auditory cortex. Nature 426:442-446.
27. Borg-Graham L, Monier C, Fr'egnac Y (1998) Visual input evokes transient and strong shunting inhibition in visual cortical neurons. Nature 393:369-373.
28. Hirsch J, Alonso J, Reid R, Martinez L (1998) Synaptic integration in striate cortical simple cells. J Neurosci 18:9517-9528.
29. Shu Y, Hasenstaub A, McCormick D A (2003) Turning on and off recurrent balanced cortical activity. Nature 423:288-293.
30. Haider B, Duque A, Hasenstaub A R, McCormick DA (2006) Neocortical network activity in vivo is generated through a dynamic balance of excitation and inhibition. J Neurosci 26:4535-4545.
31. Waters J, Helmchen F (2006) Background synaptic activity is sparse in neocortex. J Neurosci 26:8267-8277.
32. Major G, Larkman A, Jonas P, Sakmann B, Jack J (1994) Detailed passive cable models of whole-cell recorded ca3 pyramidal neurons in rat hippocampal slices. J Neurosci 14:4613-4638.
33. Roth A, H″ausser M (2001) Compartmental models of rat cerebellar purkinje cells based on simultaneous somatic and dendritic patch-clamp recordings. J Physiol 535:445-572.
34. Sarid R L nad Bruno, Sakmann B, Segev I, Feldmeyer D (2007) Modeling a layer 4-to-layer ⅔ module of a single column in rat neocortex: interweaving in vitro and in vivo experimental observations. Proc Natl Acad Sci USA 104:16353-16358.
35. Oswald A, Reyes A (2008) Maturation of intrinsic and synaptic properties of layer ⅔pyramidal neurons in mouse auditory cortex. J Neurophysiol 99:2998-3008.
36. Froemke R, Merzenich M, Schreiner C (2007) A synaptic memory trace for cortical receptive field plasticity. Nature 450:425-429.
37. Froemke R, Dan Y (2002) Spike-timing-dependent synaptic modification induced by natural spike trains. Nature 416:433-438.
38. Wang H X, Gerkin R C, Nauen D W, Bi GQ (2005) Coactivation and timing-dependent integration of synaptic potentiation and depression. Nat Neurosci 8:187-193.
39. Froemke R, Tsay I, Raad M, Long J, Dan Y (2006) Contribution of individual spikes in burstinduced long-term synaptic modification. J Neurophysiol 95:1620-1629.
40. Wittenberg G, Wang S (2006) Malleability of spike-timing-dependent plasticity at the ca3-cal synapse. J Neurosci 26:6610-6617.
41. Zatorre R, Belin P (2001) Spectral and temporal processing in human auditory cortex. Cereb Cortex 11:946-953.
42. Boemio A, Fromm S, Braun A, Poeppel D (2005) Hierarchical and asymmetric temporal sensitivity in human auditory cortices. Nat Neurosci 8:389-395.
43. Abrams D, Nicol T, Zecker S, Kraus N (2008) Right-hemisphere auditory cortex is dominant for coding syllable patterns in speech. J Neurosci 28:3958-3965.
44. Hutsler J, Galuske R (2003) Hemispheric asymmetries in cerebral cortical networks. Trends Neurosci 26:429-435.
45. Shtyrov Y, Kujala T, Ahveninen J, Tervaniemi M, Alku P, et al. (1998) Background acoustic noise and the hemispheric lateralization of speech processing in the human brain: magnetic mismatch negativity study. Neurosci Lett 251:141-144.
46. Abrams D A, Nicol T, Zecker S G, Kraus N (2006) Auditory brainstem timing predicts cerebral asymmetry for speech. J Neurosci 26:11131-11137.
47. Oertel D, Fay R, Popper A, editors (2002) Integrative functions in the mammalian auditory pathway, New York: Spriger, chapter The Inferior Colliculus: A Hub for the Central Auditory System. pp. 238-318.
48. Jusczyk P, Pisoni D, Reed M, Fernald A, Myers M (1983) Infants' discrimination of the duration of a rapid spectrum change in nonspeech signals. Science 222:175-177.
49. Eimas P D, Miller J L (1980) Contextual effects in infant speech perception. Science 209:1140-1141.
50. Gordon-Salant S, Fitzgibbons P (2001) Sources of age-related recognition difficulty for timecompressed speech. J Speech Lang Hear Res 44:709-719.
51. Gordon-Salant S, Fitzgibbons P, Friedman S (2007) Recognition of time-compressed and natural speech with selective temporal enhancements by young and elderly listeners. J Speech Lang Hear Res 50:1181-1193.
52. Caspary D, Schatteman T, Hughes L (2005) Age-related changes in the inhibitory response properties of dorsal cochlear nucleus output neurons: role of inhibitory inputs. J Neurosci 25:10952-10959.
53. Caspary D, Ling J L Turner, Hughes L (2008) Inhibitory neurotransmission, plasticity and aging in the mammalian central auditory system. J Exp Biol 211:1781-1791.
54. Schneider B, M D, Murphy D (2005) Speech comprehension difficulties in older adults: cognitive slowing or age-related changes in hearing? Psychol Aging 20:261-271.
55. Itakura F (1975) Minimum prediction residual principle applied to speech recognition. IEEE Trans Acoust Speech Signal Proc ASSP-23:67-72.
56. Myers C, Rabiner L, Rosenberg A (1980) Performance tradeoffs in dynamic time warping algorithms for isolated word recognition. IEEE Acoust Speech Signal Process ASSP-28:623-635.
57. Kavaler R A, Brodersen R W, Lowy M, Murveit H (1987) A dynamic-time-warp integrated circuit for a 1000-word speech recognition system. IEEE Journal of Solid-State Circuits SC-22:3-14.
58. Mauk M, Buonomano D (2004) The neural basis of temporal processing. Annu Rev Neurosci 27:307-340.
59. Meister M, Lagnado L, Baylor D A (1995) Concerted signaling by retinal ganglion cells. Science 270:1207-1210.
60. Neuenschwander S, Singer W (1996) Long-range synchronization of oscillatory light responses in the cat retina and lateral geniculate nucleus. Nature 379:728-732.
61. Gollisch T, Meister M (2008) Rapid neural coding in the retina with relative spike latencies. Science 319:1108-1111.
62. deCharms R C, Merzenich M M (1996) Primary cortical representation of sounds by the coordination of action-potential timing. Nature 381:610-613.
63. Johansson R S, Birznieks I (2004) First spikes in ensembles of human tactile afferents code complex spatial fingertip events. Nat Neurosci 7:170-177.
64. Wehr M, Laurent G (1996) Odour encoding by temporal sequences of firing in oscillating neural assemblies. Nature 384:162-166.
65. Louie K, Wilson M A (2001) Temporally structured replay of awake hippocampal ensemble activity during rapid eye movement sleep. Neuron 29:145-156.
66. Ji D, Wilson M A (2007) Coordinated memory replay in the visual cortex and hippocampus during sleep. Nat Neurosci 10:100-107.
67. Brette R (2006) Exact simulation of integrate-and-fire models with synaptic conductances. Neural Computat 18:2004-2027.
68. Klein D J, Depireux D A, Simon J Z, Shamma S A (2000) Robust spectrotemporal reverse correlation for the auditory system: optimizing stimulus design. J Comput Neurosci 9:85-111.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of recognizing patterns in a signal comprising:
pacing a pattern recognition element based on detected events in the signal.

2. The method according to claim 1, further comprising pacing a set of pattern recognition elements based on the detected events.

3. The method according to claim 1, further comprising spatiotemporal characterization of the signal.

4. The method according to claim 3, wherein an event is defined with respect to one or more energy level measurements within the signal.

5. The method according to claim 3, wherein the spatiotemporal characterization produces a set of pulses or spikes.

6. The method according to claim 5, wherein each pulse or spike is produced in response to an energy level measurement within a frequency band of the signal.

7. (canceled)

8. (canceled)

9. (canceled)

10. The method according to claim 1, wherein the signal is a speech signal.

11. An apparatus for recognizing patterns in a signal comprising:
a recognition element adapted to be paced based on detected events in the signal.

12. The apparatus according to claim 11, further comprising a set of pattern recognition elements adapted to be paced base on the detected events.

13. The apparatus according to claim 12, further comprising one or more signal event detectors.

14. The apparatus according to claim 13, wherein an event is defined with respect to one or more energy level measurements within the signal.

15. The apparatus according to 13, wherein the one or more signal event detectors are adapted to perform spatiotemporal characterization of the signal.

16. The apparatus according to claim 15, wherein spatiotemporal characterization produces a set of pulses or spikes.

17. (canceled)

18. (canceled)

19. (canceled)

20. (canceled)

21. The apparatus according to claim 11, wherein the signal is a speech signal.

22. A system for recognizing a speech signal comprising:
a speech signal acquisition portion; and a recognition element adapted to be paced based on detected events in the signal.

23. The system according to claim 22, further comprising a set of pattern recognition elements adapted to be paced base on the detected events.

24. The system according to claim 23, further comprising one or more signal event detectors.

25. The system according to claim 22, wherein an event is defined with respect to one or more energy level measurements within the signal.

26. The system according to 24, wherein the one or more signal event detectors are adapted to perform spatiotemporal characterization of the signal.

27. The system according to claim 26, wherein spatiotemporal characterization produces a set of pulses or spikes.

28. (canceled)

29. (canceled)

30. (canceled)
